(19) United States
(12) Patent Application Publication
(10) Pub. No.: US 2025/0329217 A1
(43) Pub. Date: Oct. 23, 2025

(54) Method and system for configuring a computing system with multiple jackpot state computer-implemented game

(71) Applicant: Games Global Operations Limited, Douglas (IM)

(72) Inventors: Paul Anthony Roland, Deerfield Beach, FL (US); Joshua James Anglum, Boca Raton, FL (US)

(21) Appl. No.: 18/642,438

(22) Filed: Apr. 22, 2024

(51) Int. Cl. G07F 17/32

(52) U.S. Cl. CPC G07F 17/3258; G07F 17/3209; G07F 17/3213; G07F 17/3262

(57) ABSTRACT

A computing system is configured to operate using a first jackpot state for a game with multiple jackpot states. A user-selectable control (USC) to initiate each instance of the game is provided at a user interface. In response to selection of the USC, a first instance of the game is performed while the computing system operates using the first jackpot state. An outcome of the first instance of the game is determined and output on a display, the outcome indicates the game should change to a second jackpot state. The computing system is configured to operate using the second jackpot state for a second instance of the game. In response to selection of the USC, the second instance of the game is performed while the computing system operates using the second jackpot state. An outcome of the second instance of the game is determined and output on the display.

### FIELD

This disclosure relates to a computer-implemented game.

### BACKGROUND

Slot machines come in a variety of forms, including for example a mechanical slot machine. A mechanical slot machine can include one or more reels, each of which includes multiple symbols distributed around the circumference of the reel. When a slot machine with reel(s) is used, a user is allowed to spin the reels. Each reel then comes to rest, typically with either one of the symbols, or a space in between symbols, in alignment with a payline. A predefined winning symbol or a predefined combination of winning symbols that are aligned with the payline can result in the user receiving an award. In one example, the slot machine can include three reels, and the payline can be an imaginary, horizontal line disposed across a central portion of a window through which a portion of each of the three reels is visible.

As another example, a mechanical slot machine can present symbols in a matrix arrangement, with each symbol changing during a use of the mechanical slot machine. For example, the mechanical slot machine can have five columns and three rows of symbols, for a total of fifteen symbols. Such mechanical slot machines often have multiple paylines, each being defined by a collection of positions within the matrix. For example, the mechanical slot machine can have three paylines, each corresponding to one row of the matrix.

While slot machines were traditionally mechanical, modern slot machines often take the form of a computing system (e.g., a dedicated computing system located in a casino) that includes a graphical user interface (GUI), and that can emulate aspects of a mechanical slot machine. Despite such advances, there is a continuing need to improve how a computing system controls the awarding of jackpot for a computer-implemented game.

### OVERVIEW

The present application discloses embodiments including and/or related to methods, computing systems, and computer-readable memories that provide improvements in controlling the awarding of jackpots in a computer-implemented game with multiple jackpot states.

In a first aspect, a method is provided. The method comprises configuring a computing system to operate using a first jackpot state for a game with multiple jackpot states. The method also includes providing, at a user interface of the computing system, a user-selectable control to initiate each instance of the game. The method further includes performing, in response to selection of the user-selectable control, a first instance of the game while the computing system operates using the first jackpot state. Additionally, the method includes determining, an outcome of the first instance of the game. The outcome of the first instance of the game includes an outcome to change from the first jackpot state to a second jackpot state. The method also includes outputting, on a display of the computing system, an outcome of the first instance of the game. Additionally, the method includes configuring the computing system to operate using the second jackpot state for a second instance of the game. Further, the method includes performing, in response to selection of the user-selectable control, the second instance of the game while the computing system operates using the second jackpot state. Furthermore, the method includes determining an outcome of the second instance of the game. Furthermore still, the method includes outputting, on the display of the computing system, the outcome of the second instance of the game.

In a second aspect, a computing system is provided. The computing system includes a processor and a non-transitory computer-readable memory comprising executable instructions. Execution of the executable instructions by the processor cause the processor to perform functions. The functions comprise configuring the computing system to operate using a first jackpot state for a game with multiple jackpot states. The functions also include providing, at a user interface of the computing system, a user-selectable control to initiate each instance of the game. The functions further include performing, in response to selection of the user-selectable control, a first instance of the game while the computing system operates using the first jackpot state. Additionally, the functions include determining, an outcome of the first instance of the game. The outcome of the first instance of the game includes an outcome to change from the first jackpot state to a second jackpot state. The functions also include outputting, on a display of the computing system, an outcome of the first instance of the game; configuring the computing system to operate using the second jackpot state for a second instance of the game. Further, the functions include performing, in response to selection of the user-selectable control, the second instance of the game while the computing system operates using the second jackpot state. Furthermore, the functions include determining an outcome of the second instance of the game. Furthermore still, the functions include outputting, on the display of the computing system, the outcome of the second instance of the game.

In a third aspect, a non-transitory computer-readable medium is provided. The non-transitory computer-readable medium comprises instructions that, when executed by a processor, cause the processor to perform functions. The functions comprise configuring the computing system to operate using a first jackpot state for a game with multiple jackpot states. The functions also include providing, at a user interface of the computing system, a user-selectable control to initiate each instance of the game. The functions further include performing, in response to selection of the user-selectable control, a first instance of the game while the computing system operates using the first jackpot state. Additionally, the functions include determining, an outcome of the first instance of the game. The outcome of the first instance of the game includes an outcome to change from the first jackpot state to a second jackpot state. The functions also include outputting, on a display of the computing system, an outcome of the first instance of the game; configuring the computing system to operate using the second jackpot state for a second instance of the game. Further, the functions include performing, in response to selection of the user-selectable control, the second instance of the game while the computing system operates using the second jackpot state. Furthermore, the functions include determining an outcome of the second instance of the game. Furthermore still, the functions include outputting, on the display of the computing system, the outcome of the second instance of the game.

These aspects, as well as other embodiments, aspects, advantages, and alternatives will become apparent to those of ordinary skill in the art by reading the following detailed description, with reference where appropriate to the accompanying drawings. Further, this overview and other descriptions and figures provided herein are intended to illustrate embodiments using examples only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

The above, as well as additional, features will be better understood through the following illustrative and non-limiting detailed description of example embodiments, with reference to the appended drawings.

FIG. 1 and FIG. 2 show example distributions of wins in accordance with example embodiments.

FIG. 3 shows a distribution of jackpot wins from simulations targeting uniform distributions in accordance with example embodiments.

FIG. 4 shows a bell shape curve in accordance with example embodiments.

FIG. 5 shows a distribution of jackpot wins from simulations targeting normal distributions in accordance with example embodiments.

FIG. 6 shows a distribution of jackpot wins from simulations targeting log-normal distributions.

FIG. 7 is a block diagram of a machine, in accordance with the example embodiments.

FIG. 8 is a block diagram of a computing system, in accordance with the example embodiments.

FIG. 9 is a block diagram of two computing systems connected to one another via a computer network, in accordance with the example embodiments.

FIG. 10 and FIG. 11 show data that can be stored in a memory in accordance with the example embodiments.

FIG. 12, FIG. 13, FIG. 14, FIG. 15, FIG. 16, FIG. 17, and FIG. 18 show a graphical user interface in accordance with the example embodiments.

FIG. 19 is a block diagram of a computing system in accordance with example embodiments.

FIG. 20, FIG. 21, FIG. 22, FIG. 23, FIG. 24, FIG. 25, FIG. 26, FIG. 27, and FIG. 28 show a set of functions in accordance with the example embodiments.

All the figures are schematic, not necessarily to scale, and generally only show parts which are necessary to explain example embodiments, wherein other parts can be omitted or merely suggested.

### DETAILED DESCRIPTION

### I. Introduction

In this detailed description, several example embodiments are disclosed including, but not limited to, embodiments pertaining to performing aspects of a computer-implemented game (e.g., a digital, electronic game) with multiple jackpot states. The jackpot states can be associated with a rising rewards style jackpot (described below).

Additionally, several example embodiments are disclosed including, but not limited to, embodiments pertaining to performing aspects of the game using a computing system (e.g., a server and/or a client computing system), a user device and/or a machine. The user device and/or the machine can be configured as and/or include a computing system. For purposes of this description, unless the context dictates otherwise, a user device or machine can include and/or be embodied as a computing system.

As an example, a game can be arranged as a game with rising rewards style jackpots. The game can include multiple jackpots and spinnable reels (e.g., five jackpots and five spinnable reels), such as one jackpot per spinnable reel of the game. Each jackpot has a prize pot associated therewith. During gameplay, the values of the prize pots can be output on a display and increase as a potential prize is added to the relevant prize pots. When the jackpot is won by the player, the full value of the prize pot associated with the jackpot is awarded to the player as a prize, and the value of the awarded prize pot resets. The full value of the prize pot can be less than the maximum (i.e., capped) prize if the jackpot is won prior to reaching a penultimate state of the game. In at least some embodiments, awarding a particular prize pot corresponding to a particular reel among multiple reels does not result in awarding or resetting of a prize pot corresponding to a different reel among the multiple reels.

As an example, a prize pot can be specified as amount of prize money. The amount of prize money can be increased as the jackpot state increments from an initial jackpot state towards a maximum (i.e., capped) amount of prize money corresponding to a final jackpot state corresponding to a game.

As another example, a prize pot can be specified as a quantity of free spins of the game. The quantity of free spins can be incremented as the jackpot state increments from an initial jackpot state towards a maximum (i.e., capped) quantity of free spins corresponding to a final jackpot state corresponding to a game.

As yet another example, a prize pot can be specified as a multiplier value. The multiplier value can be incremented as the jackpot state increments from an initial jackpot state towards a maximum (i.e., capped) multiplier value corresponding to a final jackpot state corresponding to a game. Other examples of prizes corresponding to the prize pot are possible.

A game including rising rewards style jackpots can include a fixed return-to-player (RTP), such as 96%. The awards associated with jackpots can contribute to the RTP of the game. For instance, if a rising rewards jackpot defines 20% of the game's total RTP, and the value of the prize pots is $2,000, then a probability of hitting the jackpot must be 0.2/2,000=0.01%. The remaining 76% of the overall game RTP can then be allocated to other awards, for example additional jackpots and base game wins, such as 3 of a kind, 4 of a kind, 5 of a kind or the like on one reel, payway, or payline.

In accordance with at least some embodiments, a base game win can be based on symbols being displayed on multiple reels according to a pattern of symbols (e.g., a predefined pattern of symbols). The pattern can be defined as a payline of a line-type outcome event, or a payway of a ways-type outcome event. Unless the context of the specification dictates otherwise, an embodiment in which outcomes are based on paylines and/or a line-type outcome event, can instead be based on payways and/or a ways-type outcome event, and vice versa.

In a line-type outcome event, each payline is a pattern on reels or a matrix. The payline typically starts from a left-most reel and passes through adjacent reels until the payline reaches the right-most reel. The quantity of paylines active for a line-type outcome event can depend upon a payment and/or a selection made to perform the line-type outcome event.

In a ways-type outcome event, each payway includes a combination of matching symbols located on adjacent reels. The symbols can be in any position on one of the adjacent reel. As an example, for outcome events performed on a computing system having a display screen, the outcome events can be arranged with five reels and three rows such that there are 243 payways with three or more symbols possible. The quantity of payways active for a ways-type outcome event can depend upon a payment and/or selection made to perform the ways-type outcome event.

In accordance with the example embodiments, a pattern that results in an award can include a particular pattern that starts at either side of a symbol-display portion of a display (e.g., a left side or a right side). For example, in an embodiment in which the symbol-display portion includes a respective reel in five columns referred to as C1, C2, C3, C4, C5 as those columns are arranged from a left side of the symbol-display portion to a right side of the symbol portion, the particular pattern (e.g., a payline or payway) can include a pattern with a sufficient quantity and kind of symbols starting at column C1, or a pattern with a sufficient quantity and kind of symbols starting at column C5. For instance, if the sufficient quantity and kind of symbols equals three “K” symbols, then a pattern of “K” symbols in columns C1, C2, C3 or in columns C5, C4, C3 results in an award. Moreover, in some embodiments, a special symbol, such as a “Wild” symbol can take the place of the kind of symbol defined for the particular pattern. Other examples of the sufficient quantity and kind of symbols are possible.

Some of the described embodiments refer to multiple patterns (e.g., multiple particular patterns). In one respect, the multiple particular patterns can be multiple particular paylines. In another respect, the multiple particular patterns can be multiple particular payways. Moreover, a particular pattern can be a particular payline or a particular payway. Furthermore, a winning pattern can be a winning payline or a winning payway. Furthermore still, a horizontally extending pattern can be a horizontally extending payline or a horizontally extending payway. Similarly, a diagonally extending pattern can be a diagonally extending payline or a diagonally extending payway.

Moreover, displaying the symbols can include displaying an image of one or more reels or a matrix, together with animation effects to simulate a spin of the one or more reels, or a spin of the columns or rows of the matrix. A computer software program and/or machine-readable instructions, which can reside in the computing system, can randomly select one or more symbols in response to a spin, and can display the selected one or more symbols on the display.

Additionally, an outcome event can be played over a computer-network, such as by a user using a client computing system that is connected to a server computing system over the computer-network. In this instance, the server computing system can cause the reels to spin and can send the resulting symbols to the client computing system for display.

Throughout this description, the articles “a” or “an” are used to introduce elements of the example embodiments. Any reference to “a” or “an” refers to “at least one” or “one or more,” and any reference to “the” refers to “the at least one” or “the one or more,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures can be used in combination with one another. Thus, the figures should be generally viewed as component aspects of one or more overall embodiments, with the understanding that not all illustrated features are necessary for each embodiment.

The systems, methods, and apparatus described in this description can carry out aspects of an outcome event that includes displaying symbols. These aspects can be incorporated into outcome events, in particular, outcome events performed in response to a payment. In one aspect, the systems, methods, and apparatus provide features that can enhance traditional outcome events (e.g., slot machines or other reel-type outcome events) by providing a user with additional opportunities to win the outcome event, thereby increasing the user's interest, anticipation, and excitement in connection with the outcome event. This can in turn benefit a casino or another entity that provides an outcome event with this feature. Indeed, outcome events are typically configured to have odds that favor the casino (sometimes referred to as the “house”). Accordingly, based on the law of averages, casinos often increase their profits simply by getting more users to use its computing system to perform more outcome events. Due to the provided features, users can be drawn in (e.g., from competing casinos that lack outcome events with such features), and they can play the outcome event often. The features can include data communications between a server computing system and a client computing system within a server-client based configuration.

### II. Details Regarding Rising Rewards Style Jackpot

A rising rewards style jackpot allows for a prize pot to grow in value while maintaining the RTP of the game. This can be done by dynamically determining (adjusting) the trigger chance for the jackpot on a per-spin basis. For example, the RTP of an award can be as follows.

$$\begin{matrix}RTP = p * v \\ p = probability of hitting the award \\ v = the value of the award\end{matrix} \qquad Equation 1$$

The value of the award, v, can be referred to as a jackpot value, a value of a jackpot, a prize pot value, or a value of a prize pot.

To maintain a constant RTP as the jackpot value grows, a probability simply needs to scale down by the same amount of the increase. For example, if the jackpot value has increased to 3/2 an original value of the jackpot value, the probability will be ⅔ the original chance. Or in more general if the value increases by a factor of x, then:

$${RTP}^{′} = ( \frac{1}{x} ) p * xv = ( \frac{x}{x} ) * p * v = 1 * p * v = p * v = RTP . \qquad Equation 2$$

This has the effect of allowing a state of the jackpot to be saved independent of the player's bet. For example, for a bet size set to $2 for a game having a rising reel jackpot, a value of the prize pot for that bet size can be set to $21, and changing the bet size to $50 (i.e., 25 times higher) adjusts value of the prize pot in the same relation, to $525 (i.e., 25 times higher).

The embodiments with rising rewards style jackpots can provide for controlling how an increment rate of jackpot values is adjusted as the jackpot grows, along with keeping the RTP constant as the jackpot grows and decreasing the probability of triggering the jackpot proportionally.

In that regard, a desired distribution of wins over different possible states of a jackpot can be chosen, and control data can be adjusted so that gameplay results in the desired distribution. As a result, on any given spin at state n, one of the following three types of defined outputs can occur:

$$\begin{matrix}Output type 1 : No effect on the jackpot ( with probability {p}_{x}^{m} ) ; \\ Output type 2 : Increment the jackpot ( with probability {p}_{i}^{n} ) ; or \\ Output type 3 : Increment and award the jackpot ( with probability {p}_{t}^{n} ) . \\ The probabilities in those output types sum to 1 , i . e . , {p}_{x}^{n} + {p}_{i}^{n} + {p}_{t}^{n} = 1.\end{matrix} \qquad Equation 3$$

The following control aspects correspond to the three defined output types. First, because the jackpot is capped at some value and the jackpot can only be awarded with an increment (for output type 3), the jackpot cannot reach the cap without immediately being awarded. The capped value is a maximum value of a prize pot for a particular jackpot. Second, the chance to increment only (Output type 2) at the penultimate jackpot state must be 0. Third, the lowest jackpot value can never be awarded.

In at least some embodiments, a weight (e.g., a non-negative integer) is calculated for each output type. The weight can be based on a current jackpot state. Once the weights have been determined, the processor 112 can call the RNG 115 (e.g., request a result from the RNG) to determine an output type for an instance of a game. In at least some embodiments, the weights corresponding to each output type are summed and provided to the RNG 115. The RNG 115 can return a random number up to an upper bound provided to the RNG 115. The upper bound can be the sum of the weights. The processor 112 can use the random number provided by the RNG to determine which output type is to be used for the instance of the game.

As an example, the output type 1 corresponds to a weight of 7, the output type 2 corresponds to a weight of 5, and the output type 3 corresponds to a weight to 2. The sum of those weights is 14. The processor 112 can provide that sum to the RNG 115. The processor 112 can determine which output type is to be used for the instance of the game based on a random number output by the RNG 115 with reference to other data, such as the data shown in Table 1.

TABLE 1

| Sum of | Random number | Action performed on Jackpot |
|---|---|---|
| Weights | generated by RNG | (i.e., output type) |
| 14 | 1 | Do nothing (output type 1) |
| 14 | 2 | Do nothing (output type 1) |
| 14 | 3 | Do nothing (output type 1) |
| 14 | 4 | Do nothing (output type 1) |
| 14 | 5 | Do nothing (output type 1) |
| 14 | 6 | Do nothing (output type 1) |
| 14 | 7 | Do nothing (output type 1) |
| 14 | 8 | Increment the jackpot (output type 2) |
| 14 | 9 | Increment the jackpot (output type 2) |
| 14 | 10 | Increment the jackpot (output type 2) |
| 14 | 11 | Increment the jackpot (output type 2) |
| 14 | 12 | Increment the jackpot (output type 2) |
| 14 | 13 | Increment and award the jackpot |
| | | (output type 3) |
| 14 | 14 | Increment and award the jackpot |
| | | (output type 3) |

Considering the aforementioned control aspects, a process for describing the probabilities of the three possible outcomes on each spin can be defined. In the following description, “jackpot state” can be used to describe a possible value of the jackpot. Since the jackpot states are ordered, incrementing from jackpot state ‘n’ would put the jackpot into state ‘n+1’. Moreover,

$${p}_{t}^{n}$$

is calculated in the same manner as Equation 1 for

$$RTP ( RTP = {p}_{t}^{n} * v ,$$

where p is the value at state n+1). In at least some embodiments,

$${p}_{x}^{n}$$

is not a useful probability to control and is left to be defined as:

$${p}_{x}^{n} = 1 - {p}_{i}^{n} + {p}_{t}^{n} . \qquad Equation 4$$

The only remaining probability to calculate is

$${p}_{i}^{n}$$

(i.e., the probability of incrementing and not triggering the jackpot). The example embodiments can perform such calculation and perform the game based on such calculation such that a greater level of jackpot control is gained as a result.

Additionally, a potential return of a game can be linked to a bet size. Adjusting the bet size can have a direct relation to the potential winnings, as the likelihood of the potential winnings remains constant with the present type of jackpot, as shown above. When adjusting a bet size, the probability of winning can remain the same, thus changing the potential return and keeping the RTP of the game constant.

In some respects, these types of jackpots are defined with an upper limit on the value to ensure that the jackpot will eventually be hit, while controlling the game's maximum exposure (i.e., limiting the jackpot value so as not to pay out an excessive amount to a player). Without this capping, it is possible for the jackpot to grow uncontrollably, with the result that the probability of triggering approaches 0%. This is obviously undesirable, as a player could then be playing with close to a zero chance of winning the jackpot that they have spent a significant time growing during gameplay. Significant additional gameplay may then be required to ensure a win of the jackpot.

Notably, there has never been an attempt to tune the chance of incrementing the jackpot in a controlled way. Usually, the chance/likelihood to increment remains constant as the jackpot grows.

Fine tuning the jackpots is neither easy nor intuitive. A computing system used to design a game only has a few variables to adjust: the initial jackpot value, the jackpot capping value, the chance to increment the jackpot, the amount to increment by, and the target RTP.

With these limited variables there is no simple method for: tuning or calculating the average awarded value, standard deviation, or odds of the jackpot, tuning the distribution of the possible awards, and preventing the jackpot from reaching the capping value without winning.

‘Simple’ in this context means taking the variables that may be adjusted and treating them in the math model either as constants, dynamically adjustable, or otherwise determined by a function of the current jackpot value rather than holistically.

Without changing the on-the-surface variables of the jackpot (initial value, capping value, and RTP), the computing system is left with adjusting the increment rates. If the increment rate is held as constant throughout gameplay, then there is no way to fine-tune one aspect of the jackpot without sacrificing others. For example, lowering the increment chance as the jackpot value increases will reduce the chance of hitting the capping value and lower the average value awarded, but will also change all the other probabilities in the distribution.

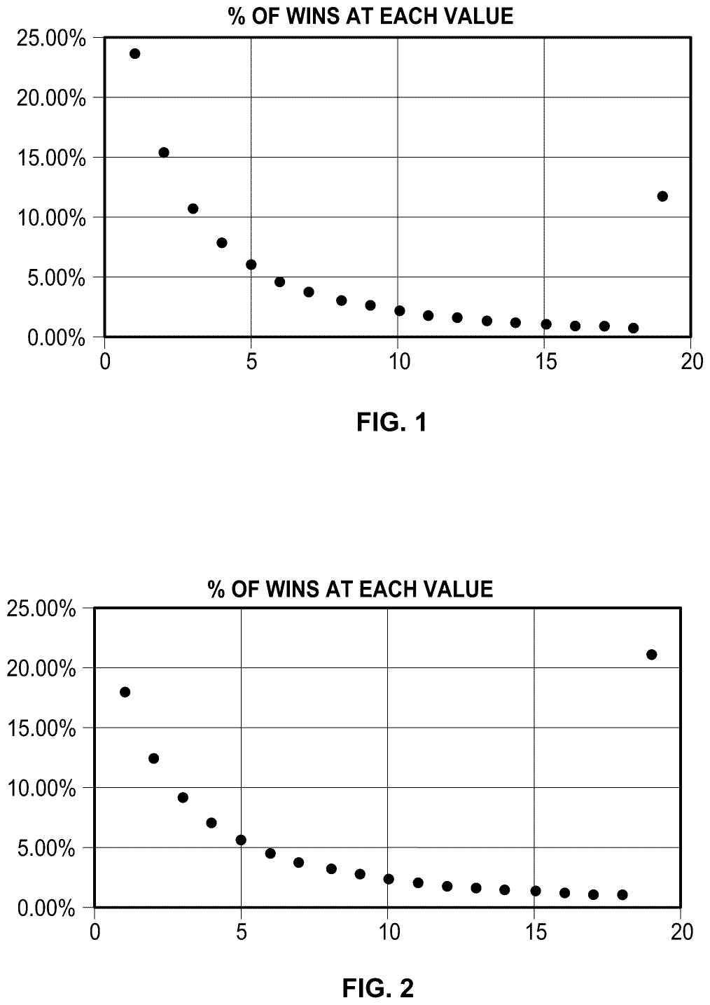

FIG. 1 and FIG. 2 show example distributions of wins across two iterations of a rising rewards style feature with a significant lack of control and ability to tune the feature discussed in other embodiments. A set of jackpot states for a game are indicated by the X-axis in FIG. 1 and FIG. 2. Both RTP and chance of increment are different between these two iterations, and the percentages have changed slightly, but the shape of the distribution has not been affected. Notably, if a jackpot is not won close to an initial stage (e.g., state 1 indicated in FIG. 1 and FIG. 2), as the probability of winning decreases as the jackpot size grows, the jackpot value often reaches its capping value, and is then won at such value. Given the small chance of winning a jackpot at the capping value (due to the direct relation between the value of the pot and the likelihood of triggering the jackpot), it can be inferred that a player needs to play for an extended duration while the jackpot is at the capping value, in order to win the pot.

In accordance with a game with rising reward style jackpots in which the RTP remains constant as the prize pot of the jackpot grows, instead of decreasing the probability of triggering the jackpot proportionally, the example embodiments provide a difference in how the increment rate is adjusted as the jackpot grows.

The example embodiments can provide a method of determining increment chances

$$( {p}_{i}^{n} )$$

such that the overall distribution of wins on the possible range (of the jackpot) matches a desired distribution. Essentially, making the distribution an input variable instead of an output. As an example, Table 2 below shows a possible jackpot range of 5 to 15.

A probability density function (PDF) can be constructed to define the probabilities of triggering from each jackpot state given a trigger, P(n) (also known as the percentage of wins at each value/state). Using this PDF, the computing system can recursively calculate the increment chances at each state so that the PDF is respected theoretically. Simply defining the PDF is not enough because P(n) is dependent on the chance of incrementing at earlier states.

The probability of triggering from each state on a given spin can be determined as described in the previous section. The following formula can be derived:

$${p}_{i}^{n} = {p}_{t}^{n} * {R}_{n} \qquad Equation 5$$

Where:
   Rₙ=the ratio of increments to triggers from state n. Equation 6
The variable Rₙ can also be expressed as:

$${R}_{n} = \frac{{C}_{n} - P ( n )}{P ( n )} \qquad Equation 7$$

Where:

$${C}_{n} = {C}_{n - 1} * \frac{{R}_{n - 1}}{1 + {R}_{n - 1}} , for n \geq 1 \qquad Equation 8$$

$${C}_{0} = 1 \qquad Equation 9$$

C=the odds of incrementing without triggering (C₀ has to be 1, given that it is at an initial setting, and there is no C₀₋₁).

The previous value (Cₙ₋₁) must be known in order to calculate the new value at Cₙ.

The embodiments can allow for any distribution to be used (including hand-picked probabilities) within some loose limits. Because the probability of triggering at each state given a trigger is known, the computing system can calculate an average value of the jackpot when awarded (as well as standard deviation and odds) and tweak the distribution to get the desired average value. This can guarantee that the player will not get stuck at the highest value just waiting to win the prize, instead as soon as they reach the max prize, it will be awarded and reset.

The embodiments of tailoring the increment probabilities can provide new control over the determination of these jackpots. This control can be gained without sacrificing player experience. The computing system can:
1. Tune and calculate the average awarded value, standard deviation, and odds of the jackpot,
2. Tune the distribution of the possible awards, and
3. Prevent the jackpot from reaching the capping value without winning.

The computing system can set any distribution on the range of jackpot values as long as the sum of the triggering and incrementing probabilities at each state does not exceed 100% or go below 0% (and each probability individually does not exceed 100% or go below 0%).

### A. First Example

In a first example, a monetary award ranges from 5 times players bet to 15 times players bet, with (fixed) increments of 0.5 times the bet and a constant RTP of 5%. From these parameters, there are 20 states that can trigger the jackpot, and

$${p}_{t}^{n} = \frac{RTP}{v}$$

can be calculated for each.

Define the PDF to be a uniform distribution. Because there are 20 states to trigger from, the PDF is

$$\frac{1}{20} = 0.05$$

for an states. Starting from n=0, calculate R₀ as follows.

$${R}_{0} = \frac{{C}_{0} - P ( 0 )}{P ( 0 )} = \frac{1 - 0.05}{0.05} = \frac{0.95}{0.05} = 19$$

Continuing,

$$\begin{matrix}{C}_{1} = {C}_{0} * \frac{{R}_{0}}{1 + {R}_{0}} = 1 * \frac{19}{1 + 19} = 0.95 \\ {R}_{1} = \frac{{C}_{I} - P ( 1 )}{P ( 1 )} = \frac{0.95 - 0.05}{0.05} = \frac{0.9}{0.05} = 18\end{matrix}$$

This process can be repeated for all 20 states. With the ratios calculated, the probability of incrementing can be calculated. The results, showing uniform distribution calculations, can be seen in Table 2. The values in

$${p}_{t}^{n} ,$$

### P(n), an

$${p}_{i}^{n}$$

are rounded for readability. More digits of precision can be used in at least some embodiments.

TABLE 2

| Value | ${p}_{t}^{n}$ | P(n) | Cₙ | Rₙ | ${p}_{i}^{n}$ |
|---|---|---|---|---|---|
| 5 | 0.00909 | 0.01178 | 1 | 19 | 0.17273 |
| 5.5 | 0.00833 | 0.01755 | 0.95 | 18 | 0.15000 |
| 6 | 0.00769 | 0.02502 | 0.90 | 17 | 0.13077 |
| 6.5 | 0.00714 | 0.03412 | 0.85 | 16 | 0.11429 |
| 7 | 0.00667 | 0.04452 | 0.80 | 15 | 0.10000 |
| 7.5 | 0.00625 | 0.05556 | 0.75 | 14 | 0.08750 |
| 8 | 0.00588 | 0.06634 | 0.70 | 13 | 0.07647 |
| 8.5 | 0.00556 | 0.07577 | 0.65 | 12 | 0.06667 |
| 9 | 0.00526 | 0.08279 | 0.60 | 11 | 0.05789 |
| 9.5 | 0.00500 | 0.08655 | 0.55 | 10 | 0.05000 |
| 10 | 0.00476 | 0.08655 | 0.50 | 9 | 0.04286 |
| 10.5 | 0.00455 | 0.08279 | 0.45 | 8 | 0.03636 |
| 11 | 0.00435 | 0.07577 | 0.40 | 7 | 0.03043 |
| 11.5 | 0.00417 | 0.06634 | 0.35 | 6 | 0.02500 |
| 12 | 0.00400 | 0.05556 | 0.30 | 5 | 0.02000 |
| 12.5 | 0.00385 | 0.04452 | 0.25 | 4 | 0.01538 |
| 13 | 0.00370 | 0.03412 | 0.20 | 3 | 0.01111 |
| 13.5 | 0.00357 | 0.02502 | 0.15 | 2 | 0.00714 |
| 14 | 0.00345 | 0.01755 | 0.10 | 1 | 0.00345 |
| 14.5 | 0.00333 | 0.01178 | 0.05 | 0 | 0.00000 |
| 15 | | | | | |

The last row of Table 2 only has a value, and the rest is empty. This is because the jackpot cannot reach the last state without triggering, so it is impossible to be in this state for these calculations to be performed. This corresponds to the first control aspect discussed above.

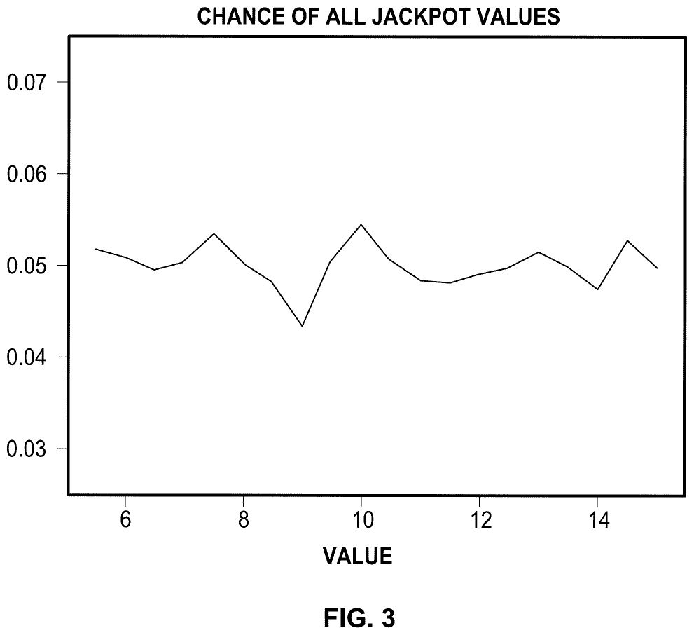

FIG. 3 shows a distribution of jackpot wins from simulations targeting uniform distributions based on Example 1 described above.

### B. Second Example

For a second example, keep the same values 5 to 15 from the first example above, but switch the distribution to a standard normal curve. Define the PDF using the formula for the normal curve:

$$f ( x ) = \frac{1}{σ \sqrt{2 π}} {e}^{- \frac{1}{2} {( \frac{x - μ}{σ} )}^{2}} where σ = 1 , μ = 0 \qquad Equation 10$$

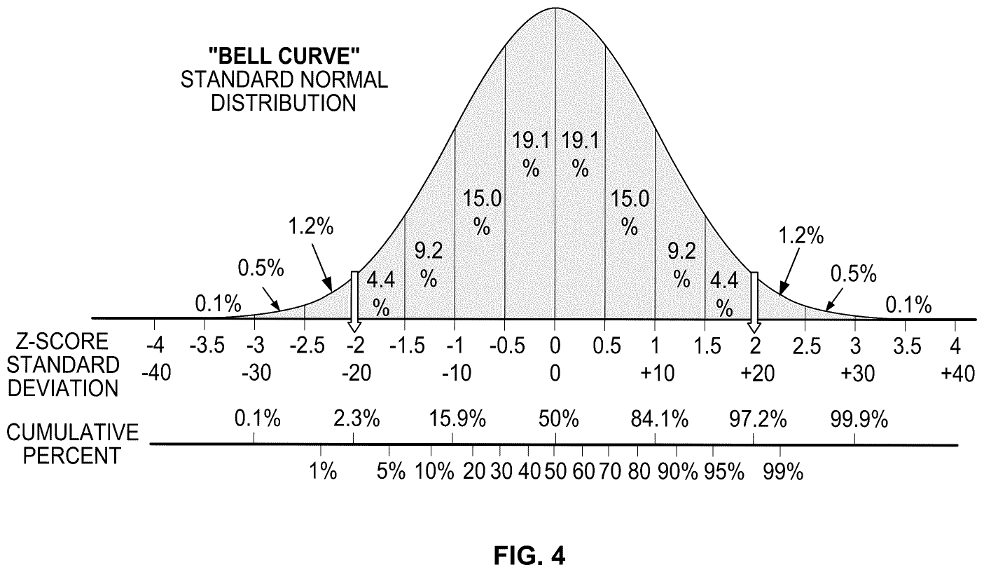

In this example, x values are selected to correspond to each state of the jackpot. In this case, pick twenty equally spaced values from −2 to 2 to give the desired bell shape, as shown in FIG. 4. The x values are plugged into f(x) for the second example to calculate a probability density to correspond to each state (i.e., the values 5 to 14.5) notwithstanding state 15. These values will not sum to 1, so they must be normalized to get P(n). Follow the formula for Cₙ and Rₙ, and finally calculate

$${p}_{i}^{n} .$$

Table 3 includes data for standard normal distribution calculations. More digits of precision can be used for data within Table 3 in at least some embodiments.

TABLE 3

| Value | ${p}_{t}^{n}$ | x | f(x) | P(n) | Cₙ | Rₙ | ${p}_{i}^{n}$ |
|---|---|---|---|---|---|---|---|
| 5 | 0.00909 | −2 | 0.05399 | 0.01178 | 1.00000 | 83.90455 | 0.76277 |
| 5.5 | 0.00833 | −1.78947 | 0.08046 | 0.01755 | 0.98832 | 55.30526 | 0.46088 |
| 6 | 0.00769 | −1.57895 | 0.11470 | 0.02502 | 0.97067 | 37.79523 | 0.29073 |
| 6.5 | 0.00714 | −1.36842 | 0.15642 | 0.03412 | 0.94565 | 26.71389 | 0.19081 |
| 7 | 0.00667 | −1.15789 | 0.20407 | 0.04452 | 0.91153 | 19.47604 | 0.12984 |
| 7.5 | 0.00625 | −0.94737 | 0.25469 | 0.05556 | 0.86701 | 14.60480 | 0.09128 |
| 8 | 0.00588 | −0.73684 | 0.30410 | 0.06634 | 0.81145 | 11.23211 | 0.06607 |
| 8.5 | 0.00556 | −0.52632 | 0.34734 | 0.07577 | 0.74511 | 8.83368 | 0.04908 |
| 9 | 0.00526 | −0.31579 | 0.37954 | 0.08279 | 0.66934 | 7.08434 | 0.03729 |
| 9.5 | 0.00500 | −0.10526 | 0.39674 | 0.08655 | 0.58655 | 5.77721 | 0.02889 |
| 10 | 0.00476 | 0.105263 | 0.39674 | 0.08655 | 0.50000 | 4.77721 | 0.02275 |
| 10.5 | 0.00455 | 0.315789 | 0.37954 | 0.08279 | 0.41345 | 3.99370 | 0.01815 |
| 11 | 0.00435 | 0.526316 | 0.34734 | 0.07577 | 0.33066 | 3.36388 | 0.01463 |
| 11.5 | 0.00417 | 0.736842 | 0.30410 | 0.06634 | 0.25489 | 2.84225 | 0.01184 |
| 12 | 0.00400 | 0.947368 | 0.25469 | 0.05556 | 0.18855 | 2.39357 | 0.00957 |
| 12.5 | 0.00385 | 1.157895 | 0.20407 | 0.04452 | 0.13299 | 1.98737 | 0.00764 |
| 13 | 0.00370 | 1.368421 | 0.15642 | 0.03412 | 0.08847 | 1.59280 | 0.00590 |
| 13.5 | 0.00357 | 1.578947 | 0.11470 | 0.02502 | 0.05435 | 1.17221 | 0.00419 |
| 14 | 0.00345 | 1.789474 | 0.08046 | 0.01755 | 0.02933 | 0.67106 | 0.00231 |
| 14.5 | 0.00333 | 2 | 0.05399 | 0.01178 | 0.01178 | 0.00000 | 0.00000 |
| 15 | | | | | | | |

### C. Third and Fourth Examples

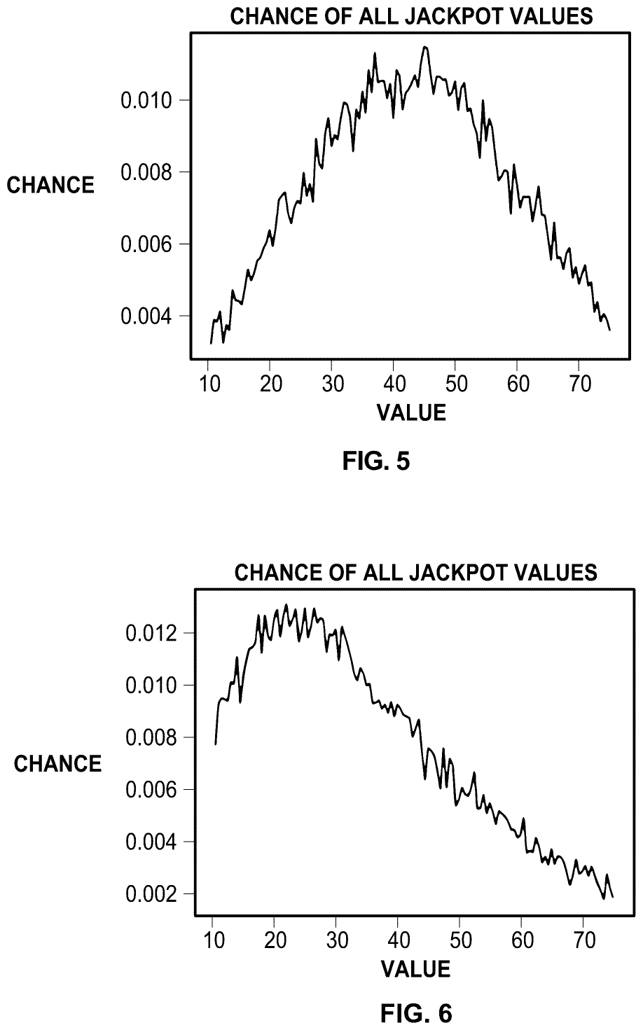

The first and second examples above are for games including 20 jackpot states. In accordance with the example embodiments, games having more jackpots states, such as thousands of jackpot states are possible. FIG. 5 shows a distribution of jackpot wins from simulations targeting normal distributions for jackpot states 10 to 75 with an increment size of 0.5. FIG. 6 shows a distribution of jackpot wins from simulations targeting log-normal distributions for jackpot states 10 to 75 with an increment size of 0.5. These distributions have more variance due to the greater number of jackpot values (e.g., points on the graphs shown in FIG. 5 and FIG. 6), but the shapes of the distributions are clearly visible.

### D. Triggering Examples

In accordance with at least some embodiments, a probability of triggering a jackpot is directly related to a value of the jackpot (given the desired fixed RTP of a game), but the likelihood of increasing the jackpot is carefully controlled. By controlling the likelihood of increasing the jackpot value at each possible state of the jackpot, the likelihood of reaching the maximum value of the jackpot, and hence offering the user the lowest possible chance of triggering the jackpot, can be reduced.

The desired jackpot payout at each possible state thereof is defined, after which the odds of triggering at each point is calculated. This is then used to calculate the odds of incrementing the jackpot (i.e., with the control aspects defined above, incrementing and triggering at the same time) at each state.

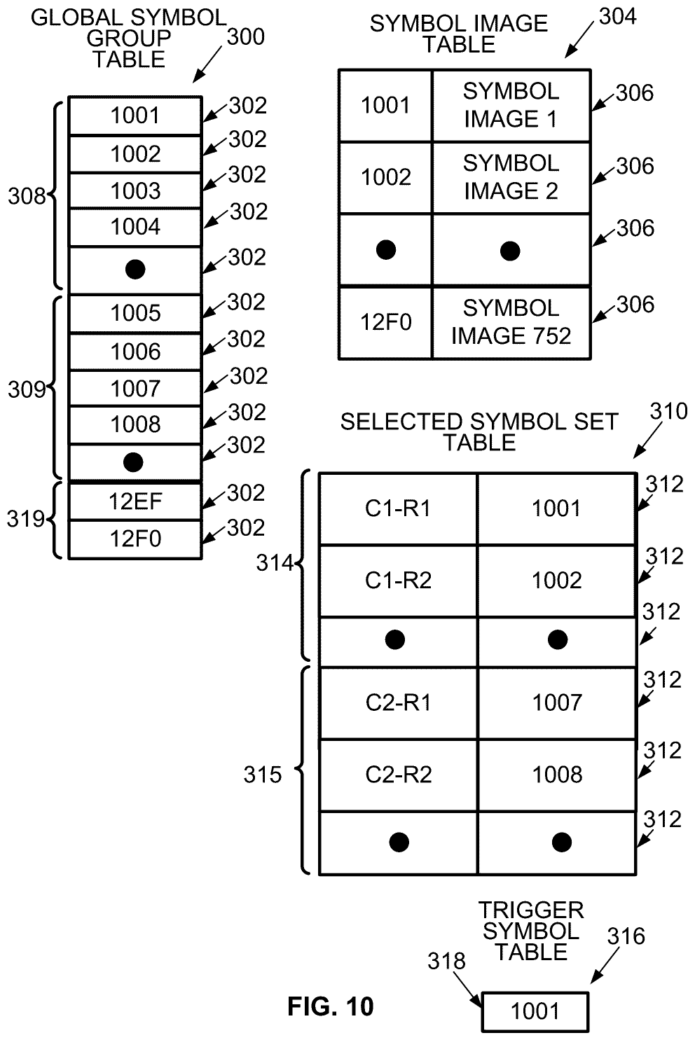

Enforcing the required odds of incrementing and/or triggering can be done in any appropriate way, whether by forcing a trigger at the specific odds, using a reel set with the appropriate odds of triggering, using a random trigger, etc. The type of trigger may influence the method that is used to trigger. In at least some embodiments, a special coin can land on the reels, possibly as a symbol that is overlaid onto another symbol on the reels. By randomly determining (according to the specific odds that are determined) whether or not the coin lands on the reels, the appropriate odds of incrementing and/or triggering can be enforced. The special coin can be represented as a symbol, such as a symbol from a sub-group 319 of symbols shown in FIG. 10.

While the examples above provide for a single jackpot, in accordance with the example embodiments a game may include multiple different “Rising Rewards” type jackpots, active at the same time.

### III. Example Architecture

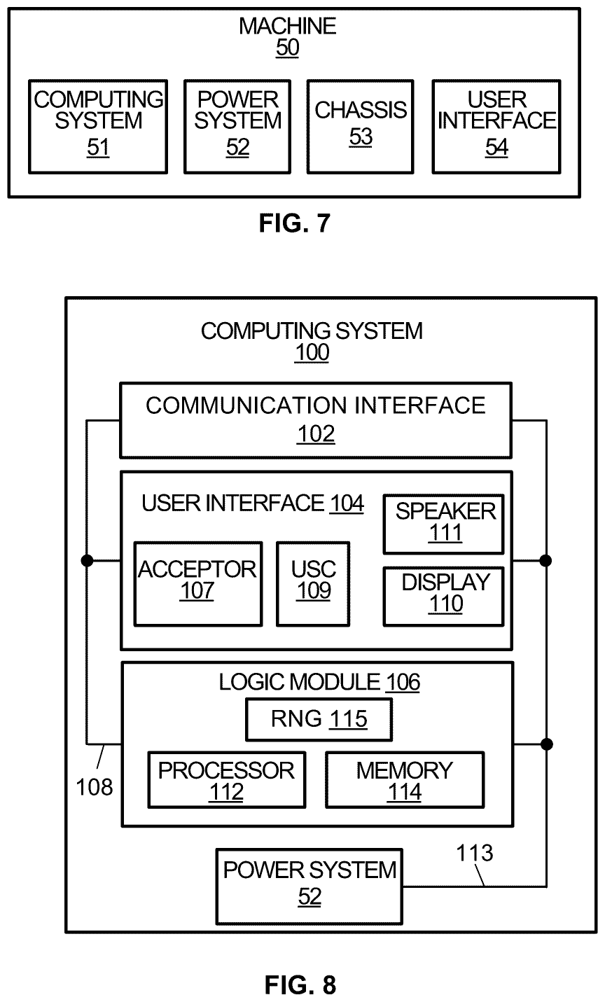

Next, FIG. 7 is a block diagram of a machine 50 in accordance with the example embodiments. The machine 50 includes a computing system 51, a power system 52, a chassis 53, and/or a user interface 54. The machine 50 can be configured to perform a method or at least some or all functions of a method according to the example embodiments. In at least some embodiments, the computing system 51 can include at least a portion of one or more from among: the power system 52, the chassis 53, or the user interface 54.

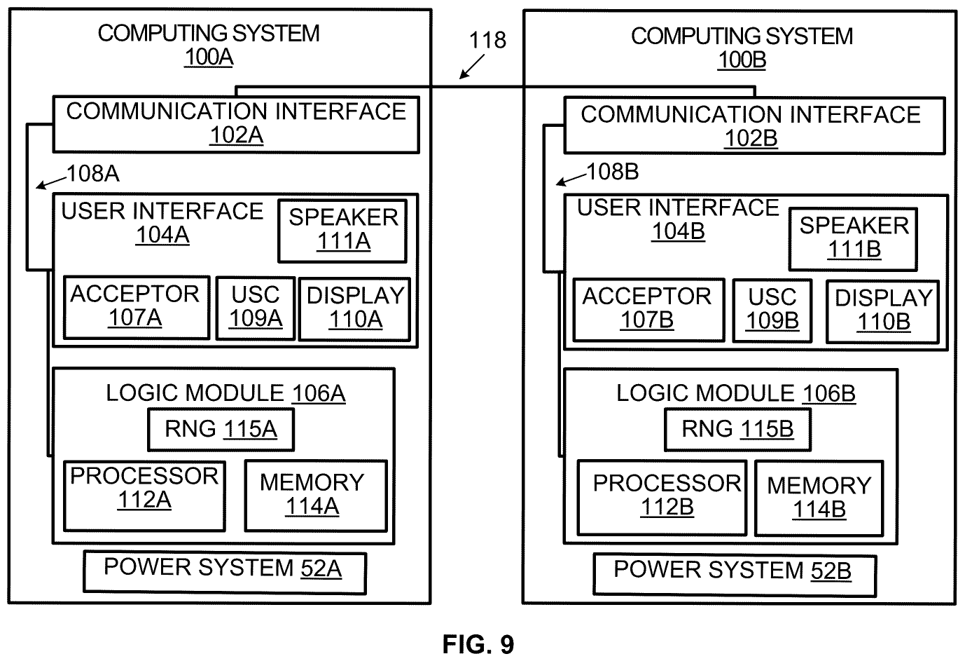

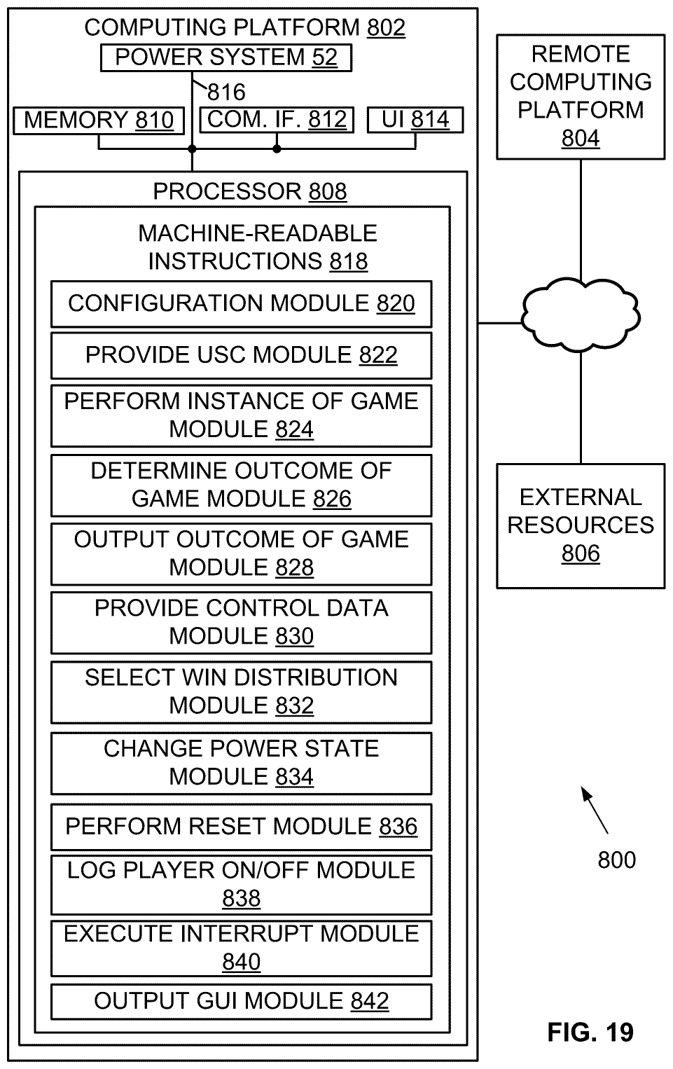

The computing system 51 can include a processor and a memory storing program instructions executable by the processor to perform a method or at least some functions of a method according to the example embodiments. As an example, the computing system 51 can be arranged as and/or include components of any computing system described in this description and/or shown in the drawings. In particular, the computing system 51 can be arranged as and/or include components of a computing system 100 shown in FIG. 8, a computing system 100A shown in FIG. 9, a computing system 100B also shown in FIG. 9, or a computing system 800 shown in FIG. 19.

The power system 52 includes means for powering one or more aspects of the machine 50, such as the computing system 51, the user interface 54, and/or some other computing system, such as another computing system described in this description. The power system 52 can include a power supply, such as a battery, a generator, a fuel cell, or a solar cell, and/or some other type of power supply. The power system 52 can include a power circuit (e.g., one or more power circuits) for distributing electrical power throughout the machine 50 where needed. The power system 52 can include a connector and/or connection for connecting to another power system, such as a power system within a building and/or a power system of an electrical utility company.

The chassis 53 includes means for supporting and/or protecting other aspects of the machine 50. As an example, the chassis 53 can include a rack for supporting at least portions of the computing system 51, the power system 52, and/or the user interface 54. As another example, the chassis 53 can include a housing in which at least portions of the computing system 51, the power system 52, and/or the user interface 54 reside. The chassis 53 can include a smart phone or tablet case configured for supporting components within the smart phone or tablet chassis.

The user interface 54 can include one or more user interface input components configured to receive and/or produce content (e.g., a signal, data, and/or information) based on some action of a user. That content can be provided to the computing system 51. The user interface 54 can include one or more user interface output components for outputting content. That content can be provided by the computing system 51 or another computing system, such as a server computing system. The user action can occur by use of the user interface 54. As an example, the user interface 54 can include a display operable to output content for viewing by a user. The output content can include an animation, a reel, a symbol, a GUI, an outcome of an instance of performing a game and/or some other content.

In at least some embodiments, the user interface 54 includes a mechanical user interface input component, such as an arm, handle or lever located on the chassis 53 similar to an arm, handle, or lever located on a mechanical slot machine. As an example, the mechanical user interface input component can be configured to input a spin request to the computing system 51. In accordance with at least some embodiments, the mechanical user interface component includes a hardware button, keypad key or switch.

In at least some embodiments, the user interface 54 includes an acceptor, such as a paper money acceptor, a coin acceptor, a token acceptor, a validator, and/or a card reader (e.g., a credit or debit card reader). In at least some embodiments, the user interface 54 includes a touch screen display operable as a user interface input component and a user interface output component.

In at least some embodiments, the computing system 51 includes at least a portion of the user interface 54. As an example, in embodiments in which the computing system 51 is arranged like the computing system 100, the computing system 100A, or the computing system 100B, the user interface 54 can be arranged like the user interface 104, the user interface 104A, or the user interface 104B, respectively.

Next, FIG. 8 is a block diagram of a computing system 100 in accordance with the example embodiments. The computing system 100 can be arranged as and/or include a stand-alone computing system, a computing platform, a remote computing platform, a distributed computing system, a personal computer, a server computing system, a client computing system, a portable computing system, a mobile phone, a smartphone, a tablet device, or some other computing device. The computing system 100 can be referred to as a user device.

The computing system 100 can include a communication interface 102, a user interface 104, and a logic module 106, two or more which can be coupled together by a system bus, network, or other connection mechanism 108. The communication interface 102 can include a wired or wireless network communication interface. For purposes of this description, any data described as being provided, sent, or transmitted by the computing system 100 can be data sent by the communication interface 102 over a communication network. In addition, for purposes of this description, any data described as being received by the computing system 100 can be data sent to communication interface 102 over a communication network.

The computing system 100 can include the power system 52. A power circuit 113 can connect the power system 52 to the communication interface 102, the user interface 104, and/or the logic module 106. The power circuit 113 can connect to components of the communication interface 102, the user interface 104, and/or the logic module 106.

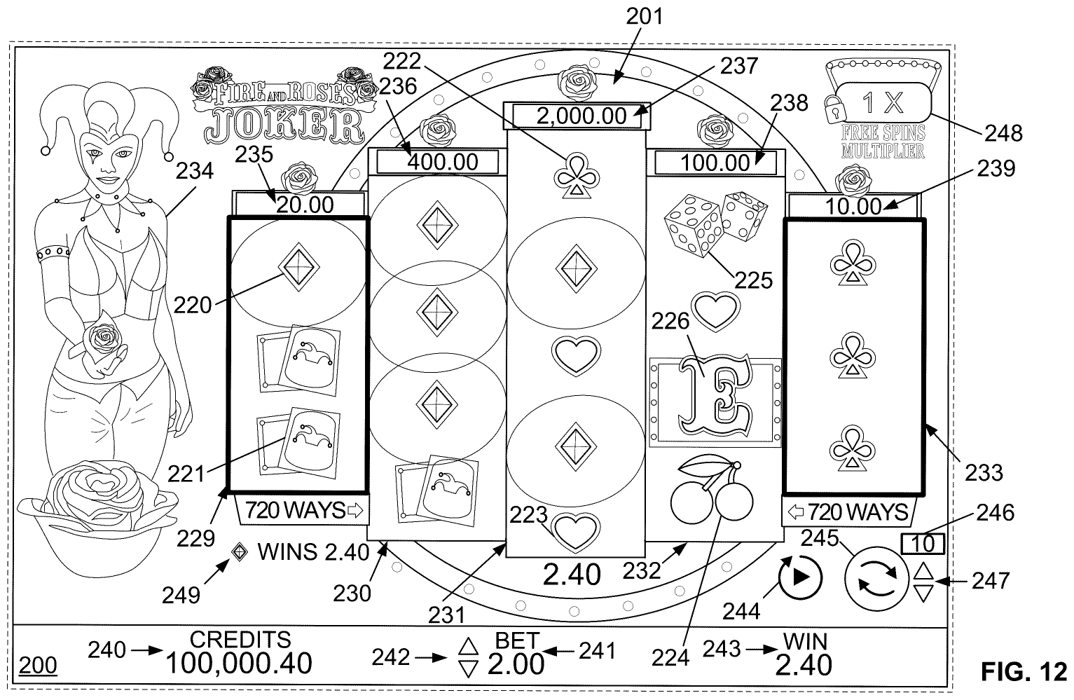

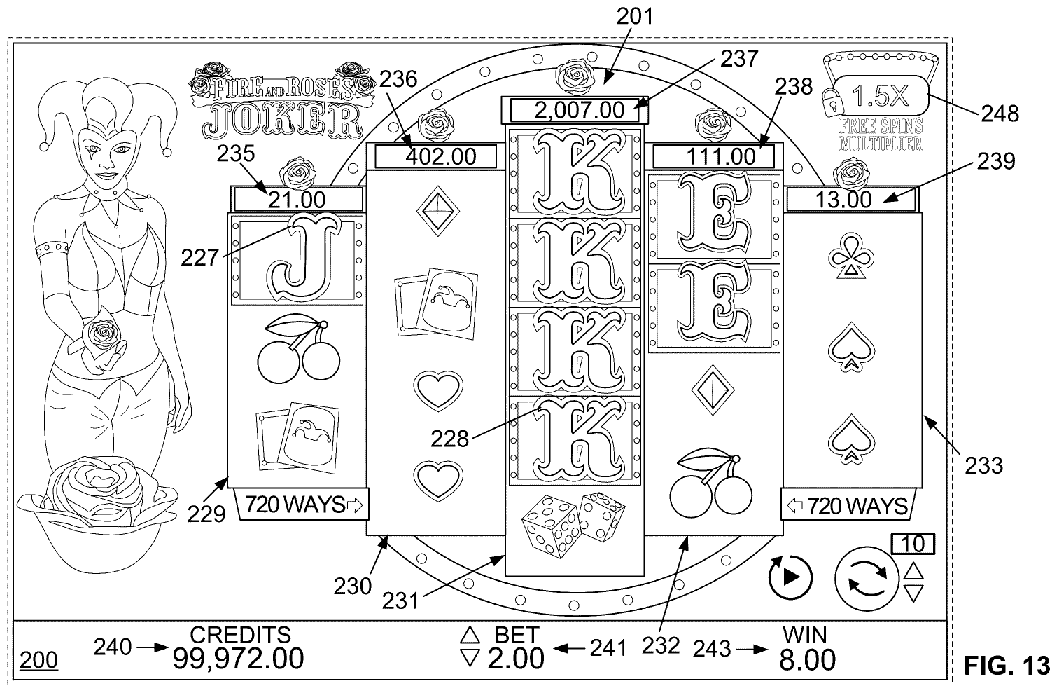

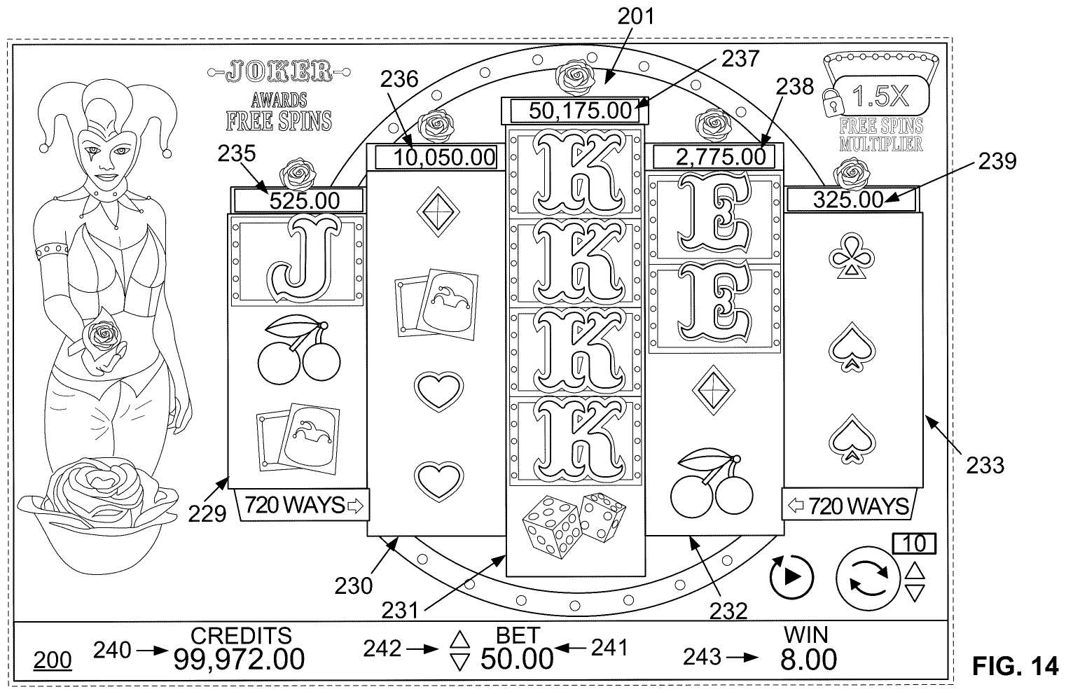

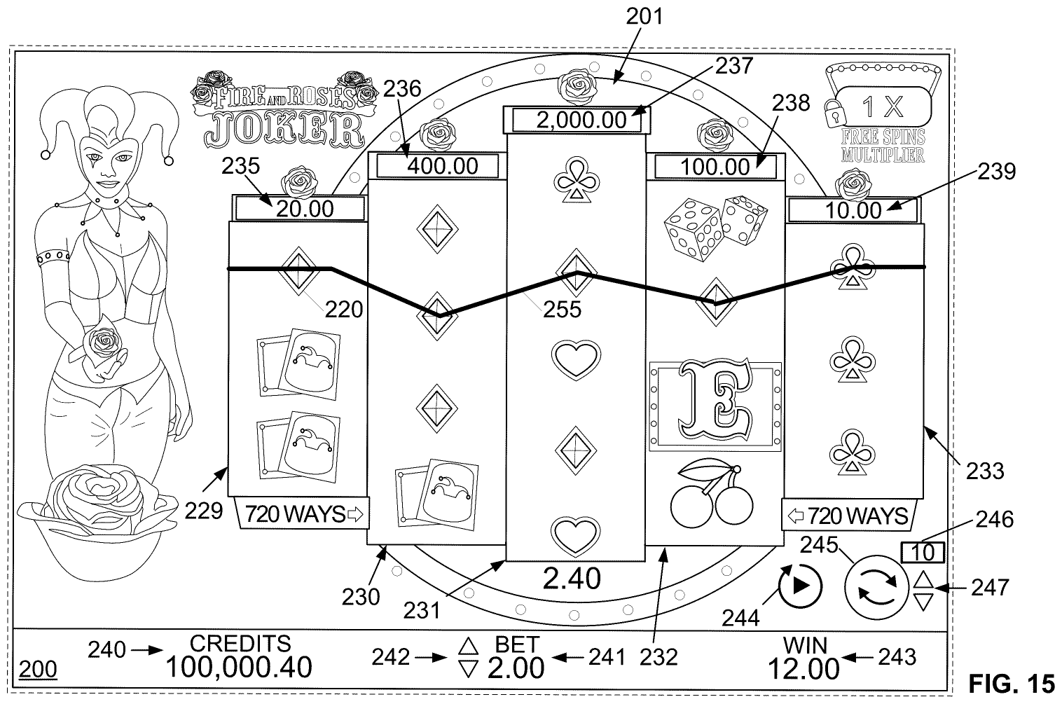

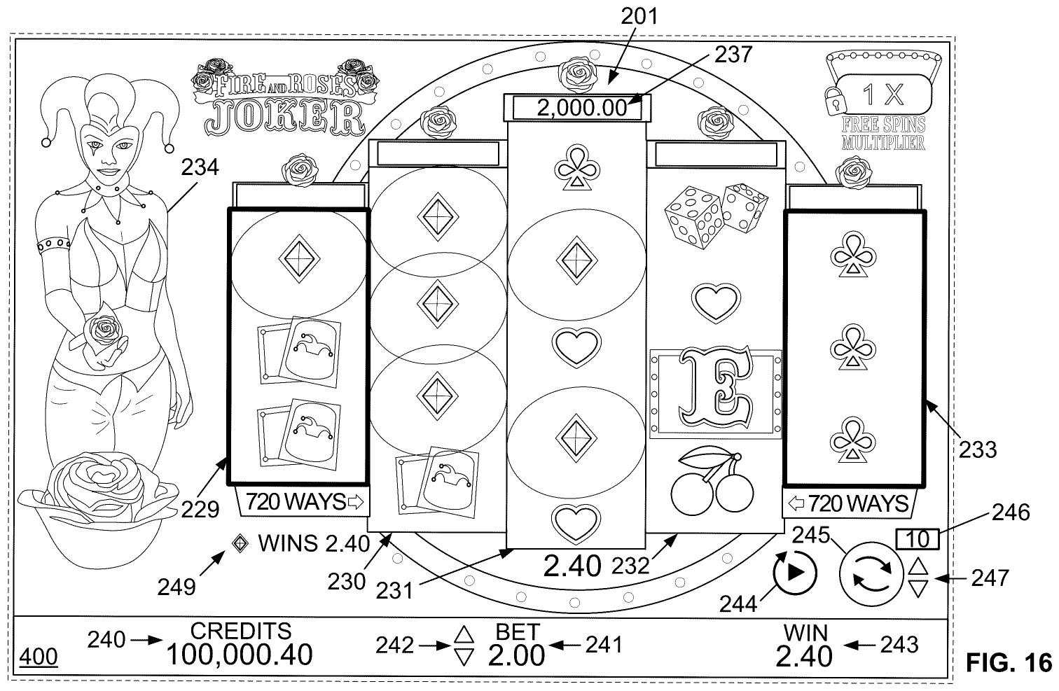

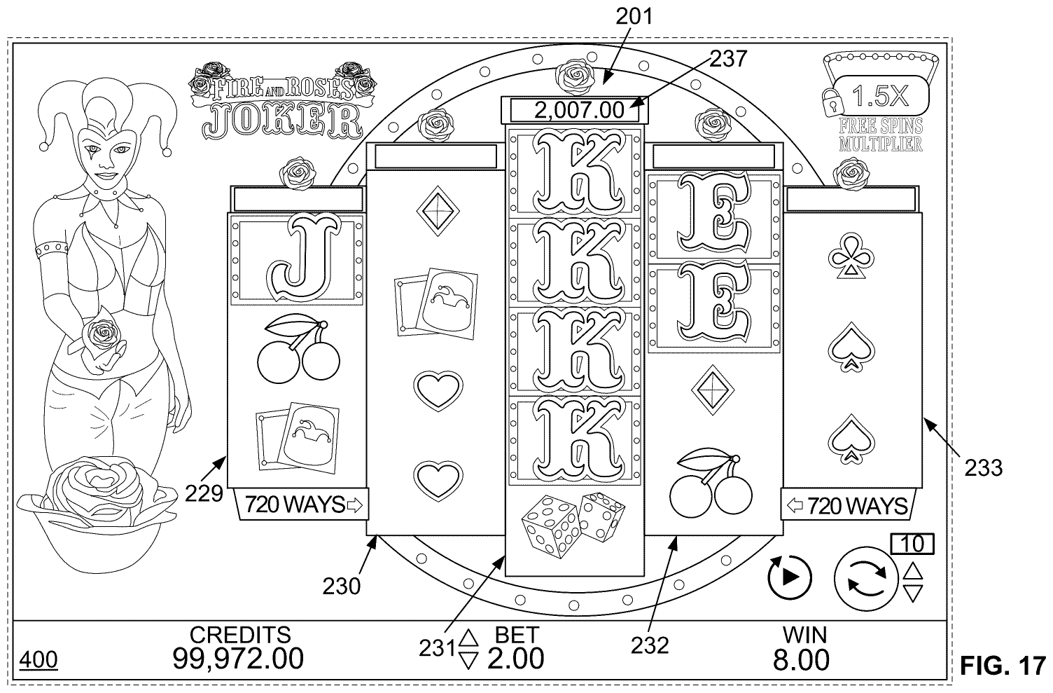

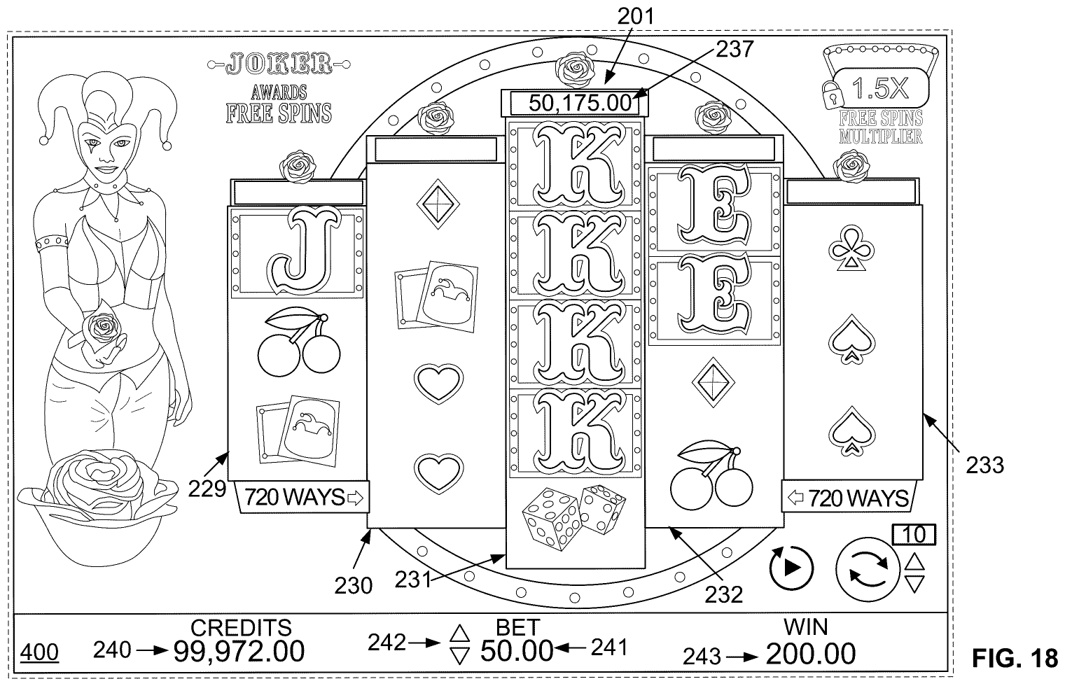

The user interface 104 includes components that can facilitate interaction with a user of the computing system 100. For example, the user interface 104 can include user interface output components, such as a display 110 and/or a speaker 111. As another example, the user interface 104 can include user interface input components, such as an acceptor 107, a user-selectable control 109 (e.g., a button, a keypad key, a keyboard, or a mouse), or a touch-sensitive screen. The touch-sensitive screen can be part of the display 110, such that the display 110 is operable as both a user interface input component and a user interface output component. The user-selectable control 109 can include one or more user-selectable controls, one or more of which can be implemented on the touch sensitive screen (which can also be referred to as a touch pad or touch screen). As an example, the user-selectable control 109 can include a cash out button and/or a user-selectable control 244, 245 shown in FIG. 12.

The display 110 is configured to display (i.e., visually present and/or show) content. As an example, the content can correspond to an outcome of performing an instance of a game, such as a set of symbols selected for the outcome event, a jackpot value, a matrix, a reel, a payline, a payway, an award, an instruction, or a user-selectable control (e.g., a button). As another example, the content can include text, a graphic, a GUI, an animation, a video, or some other content as well or instead. As yet another example, the content can include content shown in and/or described with respect to any of FIG. 12 to FIG. 18. The display 110 can include a display screen (e.g., a display panel or a graphical display unit) including a quantity of pixels (e.g., 786,432 pixels in an array of pixels that is 1,024 pixels by 768 pixels). Other examples of an array of pixels are possible.

Additionally, the display 110 and/or the display screen can include and/or be arranged as a liquid crystal display (LCD), a light emitting diode (LED) display, an organic LED (OLED) display, a plasma display or some other type of display. Furthermore, the display 110 can embody the touch sensitive screen noted above such that the display 110 and/or display screen includes and/or is arranged as a touch screen display. As an example, the touch screen display can include and/or be arranged as a capacitive touch screen display or a resistive touch screen display.

The logic module 106 can include and/or be arranged as a processor 112, a memory 114, and or a random number generator (RNG) 115. The processor 112 can include a general-purpose processor (e.g., a microprocessor) or a special-purpose processor (e.g., a graphics process, a digital signal processor or an application specific integrated circuit) and can be integrated in whole or in part with the at least a portion of the communication interface 102 and/or at least a portion of the user interface 104. Any memory discussed in this description or shown in the drawings can be referred to as a computer-readable memory, data storage, computer-readable data storage, among other names.

An RNG, such as the RNG 115 or any other RNG described in this description, can include one or more RNGs. An RNG can determine random numbers using a pseudo-random process. The processor 112 can request result(s) from the RNG 115. The result(s) can be stored in the memory 114.

In at least some embodiments, the processor 112 can request result(s) from the RNG in response to a selection of a USC (e.g., the USC 109 or a USC 244, 245 shown in FIG. 12). Each result can include a random number, such as a 64-bit random number or a random number with a different quantity of bits. In at least some embodiments, the results for an instance of the game can include multiple results from the RNG 115. For example and in general, for an embodiment in which the game includes N quantity spinnable reels, the processor 112 can request and/or receive N quantity results from the RNG (i.e., a result for each spinnable reel). As a more particular example, for an embodiment in which the game includes five spinnable reels, the processor 112 can request and/or receive five results from the RNG (i.e., a result for each spinnable reel).

In at least some embodiments, the processor 112 can map a random number to a format representing at least a partial game result. The at least a partial game result can be communicated to the user interface 104 and/or the display 110. The at least a partial fame results can indicate one or more symbols for one or more spinnable reels. The at least a partial fame results can indicate a reel position for each of one or more spinnable reels.

In at least some embodiments, a game can be implemented with multiple sets of reels. In accordance with at least some of those embodiments, each set of reels can correspond to a respective symbol image table, such as a symbol image table 304 shown in FIG. 10. The processor 112 can use the RNG 115 to select a random number indicative of a set of reels from among the multiple sets of reels. The processor 112 can use the RNG 115 to select a random number indicative of a symbol image table from among the multiple symbol image tables for determining symbols corresponding to a particular set of reels for use in an instance of a game.

The memory 114 can include volatile or non-volatile storage components and can be integrated in whole or in part with the processor 112. The memory 114 can take the form of a non-transitory computer-readable medium and can include software program instructions (i.e., machine-readable instructions), that when executed by the processor 112, cause the computing system 100 to perform one or more of the functions described herein. Any software program instructions discussed in this description or shown in the drawings can be referred to as computer-readable program instructions, or more simply, program instructions, or a software application. A set of program instructions (e.g., a portion of a software application) can be referred to as a module or a logic module.

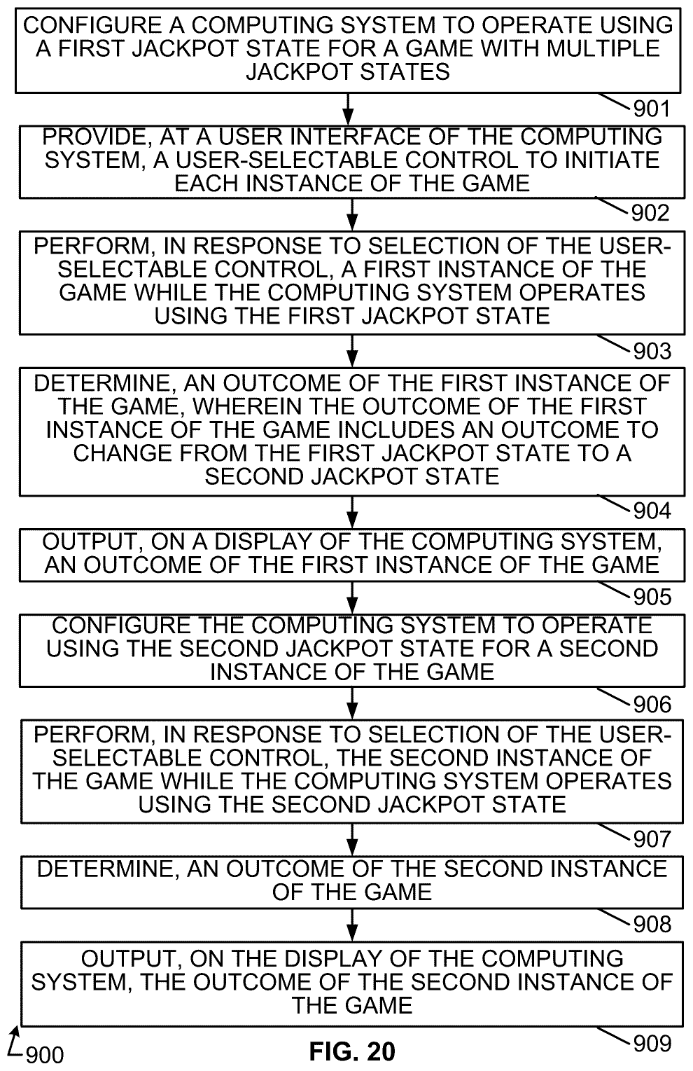

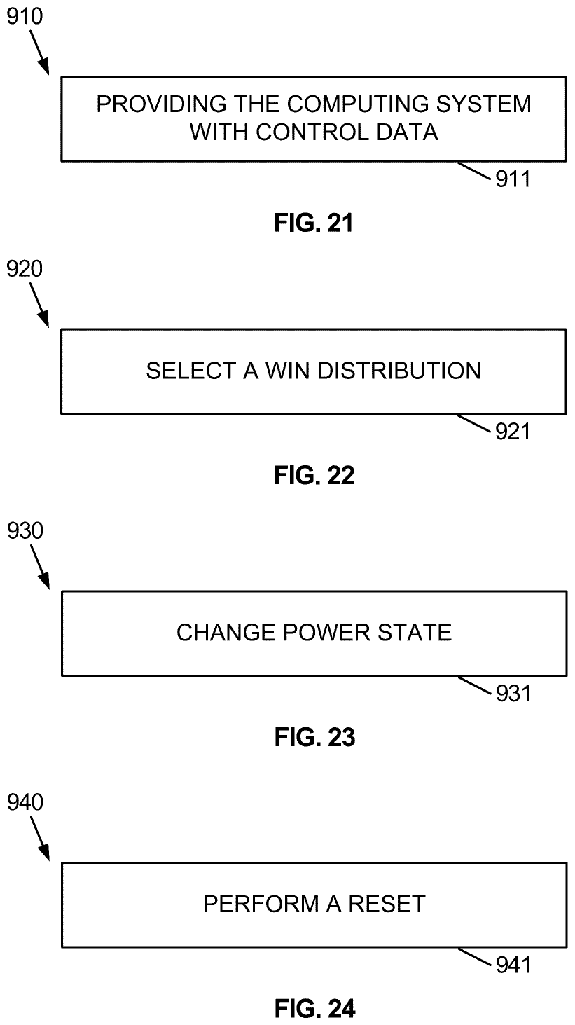

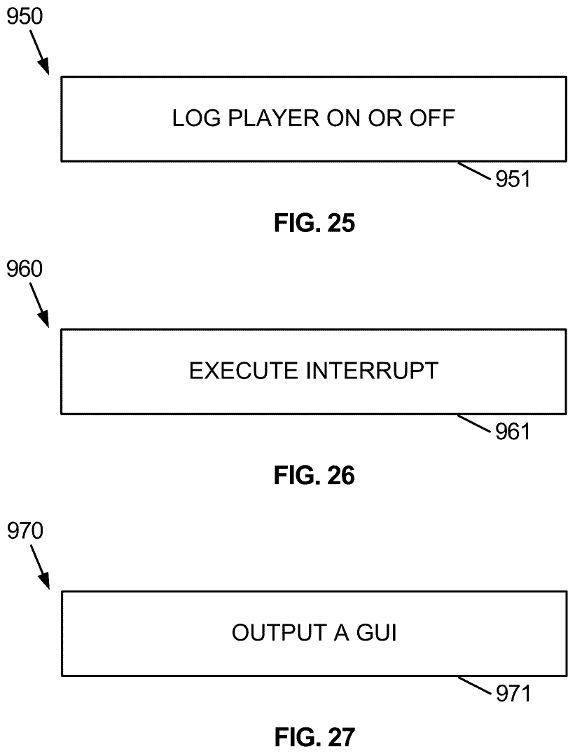

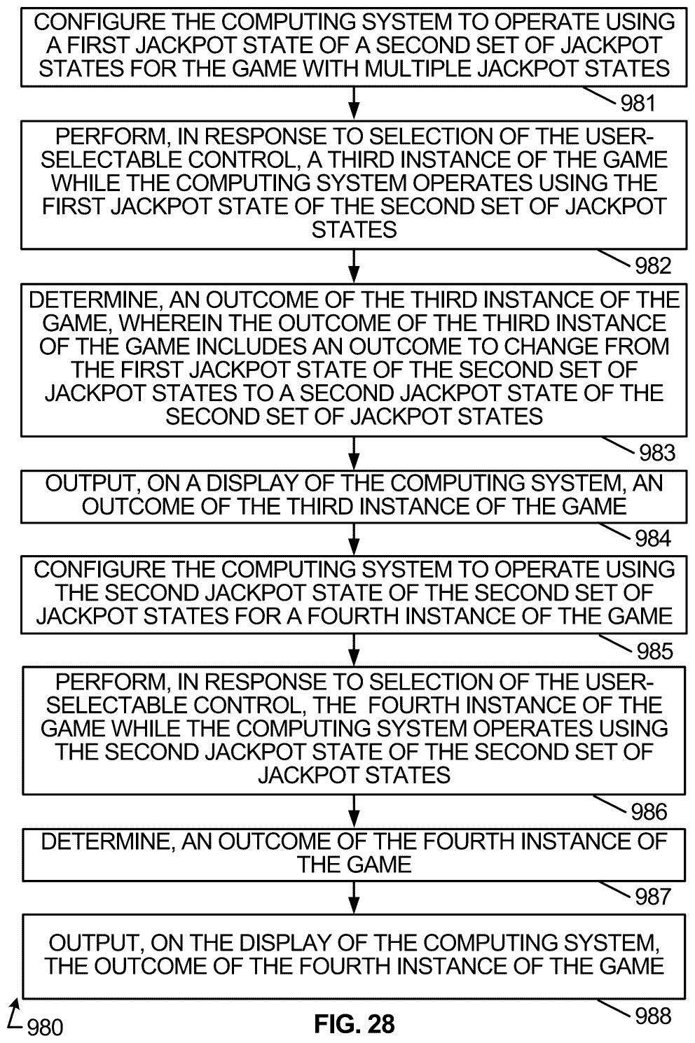

As an example, the program instructions can be executable by the processor 112 to perform a method, such as a method including one or more of the functions shown in FIG. 20 to FIG. 28.

As another example, the program instructions can be executable by the processor 112 to determine a payment has been received by the user interface 104 (e.g., by the acceptor 107) and thereafter allow an outcome to be output in response to an input entered via the user interface 104. In accordance with at least some embodiments, a module, such as a perform instance of game module 824 shown in FIG. 19, can be arranged to perform each instance of the game after a processor determines a payment for each instance of the game has been received.

The memory 114 can also include operating system software on which the computing system 100 can operate. For example, the computing system 100 can operate on a Windows®-based operating system available from the Microsoft® Corporation of Redmond, Wash. As another example, the computing system 100 can operate on an IPHONE® operating system available from Apple Inc., or an ANDROID® operating system available from Google LLC. Other examples of an operating system are possible.

The memory 114 can include a database. As an example, the memory 114 can include a credit account database containing data related to performing an instance of a game having multiple jackpot states by a computing system, as well as adjusting account balances (e.g., quantities of credits) associated with client computing systems. The processor 112 can write data into the database and read data within the database.

Next, FIG. 9 is a block diagram of a computing system 100A connected to a computing system 100B over a communication network 118. A configuration of elements including the computing system 100A and the computing system 100B can be referred to as a server-client based configuration.

The components of the computing system 100A and the computing system 100B are shown with corresponding “A” and “B” reference numerals (i.e., based on the computing system 100). For example, the computing system 100A includes a communication interface 102A, a user interface 104A (which includes an acceptor 107A, a user-selectable control 109A, a display 110A, and/or a speaker 111A), a logic module 106A (which includes a processor 112A, a memory 114A, and/or an RNG 115A), a power system 52A, and a communication bus 108A. Likewise, the computing system 100B includes a communication interface 102B, a user interface 104B (which includes an acceptor 107B, a user-selectable control 109B, a display 110B, and/or a speaker 111B), a logic module 106B (which includes a processor 112B, a memory 114B, and/or an RNG 115B), a power system 52B, and a communication bus 108B. In at least some embodiments, the acceptor 107A includes a validator, and the acceptor 107B includes a paper money acceptor, a coin acceptor, a validator, and/or a card reader. The examples corresponding to the power system 52 are applicable to the power system 52A, 52B.

The computing system 100A is configured to communicate with the computing system 100B over the communication network 118 (via the communication interface 102A and the communication interface 102B). Likewise, the computing system 100B is configured to communicate with the computing system 100A over the communication network 118. For purposes of this description, any data described as being sent or transmitted by the computing system 100A can include data sent by the communication interface 102A over the communication network 118. Similarly, any data described as being sent or transmitted by the computing system 100B can include data sent by the communication interface 102B over the communication network 118. Furthermore, for purposes of this description, any data described as being received by the computing system 100A can include data the computing system 100A receives from the communication network 118 using the communication interface 102A. Similarly, any data described as being received by the computing system 100B can include data the computing system 100B receives from the communication network 118 using the communication interface 102B.

In at least some embodiments, the communication network 118 includes a local area network (LAN), such as a LAN located at least partially within a casino. In accordance with those embodiments, multiple instances of the computing system 100B dispersed throughout the casino can communicate with the computing system 100A. In some cases, the computing system 100A can be located within the casino. In some other cases, the computing system 100A can be located away from the casino.

In another example, the communication network 118 can include a wide-area network (WAN), such as an Internet network or a network of the World Wide Web. In such a configuration, the computing system 100B can communicate with the computing system 100A via a website portal (for a virtual casino) hosted on the computing system 100A. The data described herein as being transmitted by the computing system 100A to the computing system 100B or by the computing system 100B to the computing system 100A can be transmitted as datagrams according to the user datagram protocol (UDP), the transmission control protocol (TCP), or another protocol, and/or a file (e.g., a hypertext transfer protocol file) or some other type of file or communication.

The communication network 118 can include any of a variety of network topologies and network devices. The communication network 118 can include a wireless and/or wired network topology and network devices operable on one or both of those network topologies. As an example, the communication network 118 can include a public switched telephone network, a cable network, a cellular wireless network, a wide area network (WAN), a local area network, an IEEE® 802.11 standard for wireless local area networks (wireless LAN) (which is sometimes referred to as a WI-FI® standard) (e.g., 802.11a, 802.11b, 802.11g, 802.11n, or 802.11p), and/or a network operating according to a BLUETOOTH® standard (e.g., the BLUETOOTH® standard 5.3) developed by the Bluetooth Special Interest Group (SIG) of Kirkland, Washington.

As noted, the computing system 100 can include the acceptor 107. In at least some embodiments, the acceptor 107 includes an acceptor of a physical item associated with a monetary value, such as a paper money acceptor, a coin acceptor, or a card reader. The acceptor 107 can include a validator configured to identify the physical item, and determine whether the physical item is suitable as payment to the computing system 100. A coin acceptor can be configured to accept and identify a coin distributed by a geo-political body or a token generated for an organization other than a geo-political body, such as a casino. A card reader can be configured to read a bank card (e.g., a credit or debit card) or a customer card (e.g., a casino loyalty card).

In at least some embodiments, the computing system 100 can also physically dispense a corresponding award or payout (e.g., cash), or otherwise facilitate the payout (by adding funds to an electronic account associated with a customer card). Such an activity can be triggered by a cash out button either on the display 110 or elsewhere on the computing system 100 (e.g., as part of the user-selectable control 109). Additionally or alternatively to determining the payout amount, the computing system 100 can perform other actions to award the user. For instance, the computing system 100 can display an indication of a tangible prize. Other types of awards can be used as well.

For purposes of this description, a function that can be performed by the computing system 100, the computing system 100A, or the computing system 100B can be performed, at least in part, by a processor of that computing system executing program instructions and/or a software application. Those program instructions and/or software application can be stored within the memory 114, 114A, or 114B, respectively. A random number described as being determined by the RNG 115 can be determined by the RNG 115A or the RNG 115B for implementations using the computing system 100A and/or the computing system 100B.

The memory 114 or any other memory described in this description can also store data. For example, the data contained with a memory can include a global symbol group for performing an instance of a game that includes multiple symbols, such as a reel-based game with multiple jackpot states.

In accordance with at least some embodiments, the multiple symbols can include symbols corresponding to aspects shown on a playing card of a traditional deck of playing cards. As an example, the multiple symbols can include an ace symbol, a king symbol, a queen symbol, a jack symbol, a ten symbol, a nine symbol, a heart symbol, a club symbol, a spade symbol, or a diamond symbol. In at least some embodiments, an “A” symbol represents the ace symbol, a “K” symbol represents the king symbol, a “Q” symbol represents the queen symbol, a “J” symbol represents the jack symbol, a “10” symbol represents the ten symbol, and a “9” symbol represents the nine symbol.

Examples of symbols that can be contained in the global symbol group are shown in the drawings, such as in FIG. 12 and FIG. 13. For instance, FIG. 12 shows a diamond symbol 220, a pair of cards symbol 221, a club symbol 222, a heart symbol 223, a cherry symbol 224, a dice symbol 225, and an E symbol 226, and FIG. 13 shows a jack symbol 227, and a king symbol 228.

The global symbol group can be customized with particular symbols as desired. As some possible examples, the symbols can include images of people, animals, dinosaurs, fanciful creatures, cartoon characters, inanimate objects, or other things in addition to or instead of the symbols discussed above. Even more, some symbols can indicate and/or be defined as a wild symbol. The global symbol group can be represented as a table (or other data structure) stored in the memory 114. Other examples of symbols within the global symbol group are possible.

A memory can include one or more memories. For example, a memory can include the memory 114. As another example, a memory can include the memory 114A and the memory 114B. In accordance with this latter example, a memory can be arranged as a distributed memory. One or more processors can be operatively coupled to a memory. For example, the processor 112 is operatively coupled to the memory 114. As another example, the processor 112A is operatively coupled to the memory 114A, and the processor 112B is operatively coupled to the memory 114B. In accordance with this latter example, a processor can be arranged as a distributed processor and the memory is configured as distributed memory.

Next, FIG. 10 shows data that can be stored in a memory (e.g., the memory 114, 114A, 114B, 810) in accordance with the example embodiments. In particular, FIG. 10 shows a global symbol group table 300 in accordance with the example embodiments. The global symbol group table 300 includes multiple records 302 (e.g., the data in each row of the global symbol group table 300). Each record in the global symbol group table 300 can include a numeric or alpha-numeric identifier that represents a particular symbol. In one example, the global symbol group, and therefore the global symbol group table 300, can be divided into multiple sub-groups (e.g., a sub-group 308, 309, 319).

The global symbol group table 300 can be used in connection with a symbol image table 304. The symbol image table 304 includes multiple records 306 (shown as distinct rows of the symbol image table 304), each including an identifier that represents a particular symbol, and a corresponding displayable image. As such, the symbol image table 304 can be used to map an identifier in the global symbol group table 300 to a displayable image. Such an image can be arranged according to the Joint Photographic Experts Group (JPEG), Graphics Interchange Format (GIF), or Portable Network Graphics (PNG) encodings, for example. As an example, the image can include a representation of a symbol discussed with respect to FIG. 12 and FIG. 13.

During performance of each instance of the game with multiple jackpot states, various symbol sets can be selected for display. Each selected symbol set can be stored in a table such as a selected symbol set table 310. The selected symbol set table 310 includes multiple records 312 (shown as distinct rows in selected symbol set table 310), each record including a symbol position of the symbol, and an identifier that represents the symbol. As such, each symbol in the selected symbol set can correspond to a respective symbol position in a display arrangement (e.g., both a column number and a row number in a column-and-row arrangement). As an example, C1-R1, shown in the selected symbol set table 310, represents a symbol position at column 1 (e.g., a left-most column of multiple columns in a symbol-display-portion of display 110) and row 1 (e.g., a top row of multiple rows in a symbol-display-portion of the display 110). The column identifiers in the selected symbol set table 310 (e.g., C1 and C2) can refer to columns in a symbol matrix or reels of multiple reels that can be spun.

Portions of the multiple records 312 can be grouped into a respective subset of symbol records. As an example, a subset of symbol records can include all the symbol records for a particular column or reel in a matrix. For instance, a subset 314 of symbol records can include all the symbol records for column C1 and/or a corresponding reel, and a subset 315 of symbol records can include all of the symbol records for column C2 and/or a corresponding reel. A person having ordinary skill in the art will understand that the global symbol group table 300 can include more than two subsets of symbol records, and the subsets of symbol records can correspond to an aspect other than a particular column (e.g., a particular row).

In accordance with the example embodiments, the computing system 100 can select a symbol set for outputting on the user interface 104 by iterating through each record 312 in the selected symbol set table 310. As an example, for each symbol position in the selected symbol set table 310 (i.e., each symbol position in the left-most column of the selected symbol set table 310), the processor 112 can determine a symbol identifier from among the symbol identifiers in the global symbol group table 300. In at least some embodiments, the symbol identifiers are numbers and the processor 112 uses a random number generator to determine numbers in the global symbol group table 300 to associate with each symbol position in the selected symbol set table 310. Other examples of how the computing system 100 and/or the processor 112 randomly determine symbols for the selected symbol set table 310 are also possible.

In at least some embodiments, the computing system 100 determines each symbol of the selected symbol set table 310 by randomly selecting any symbol from within the selected symbol set table 310.

In at least some other embodiments, the computing system 100 determines each symbol of the selected symbol set table 310 by randomly selecting each symbol for each subset of symbol records (e.g., the subset 314, 315 of symbol records) from a corresponding sub-group within the global symbol group table 300. For example, the computing system 100 can determine the symbols for the subset 314 of symbol records by randomly selecting symbols from the sub-group 308 and determine the symbols for the subset 315 of symbol records by randomly selecting symbols from the sub-group 309. The processor 112 can request random numbers from the RNG 115 to determine the symbols and/or symbol sets.

In at least some embodiments, the computing system 100 can determine symbols to overlay (i.e., overlay symbols) upon a reel to indicate occurrence of a trigger, such as a trigger to increment jackpot states or a trigger to indicate a jackpot win by selecting a symbol from the sub-group 319. The computing system 100 can display the overlay symbols upon other symbols on a reel within a symbol-display portion of a GUI. In at least some implementations, displaying an overlay symbol includes displaying the overlay symbol at a particular symbol position of the symbol display portion of the GUI in lieu of displaying a symbol defined for a virtual reel having symbol displayed in adjacent symbol positions of the symbol display portion of the GUI. In at least some implementations, multiple overlay symbols are displayed within the symbol display portion of the GUI to represent a game outcome.

Implementing embodiments that use overlay symbol(s) to show a jackpot change allow for jackpot events to be kept separate from the reels (i.e., the symbol used to increase or trigger the jackpot does not form part of the reels). As a result, a set of reels does not need to be adjusted or modified when changing a weighting applied to each of the three possible output types of jackpot events. As a result, the quantity of reel sets that must be available can be less than if the overlay symbol(s) are not used and/or fewer calculations are required in order to modify the reels). Such embodiments allow a game designer to apply any PDF they desire without the need to craft a reel set to match the desired PDF.

In at least some embodiments, the computing system 100 can first determine the symbols within the selected symbol set table 310 from the global symbol group table 300 and then determine a symbol position for each of those symbols. Determining the symbol position for a symbol can include the computing system 100 randomly selecting a symbol position from among multiple remaining, unassigned symbol positions and assigning the selected symbol position to one of the predetermined symbols. As an example, selecting the symbol position for an embodiment in which the display arrangement is a column-and-row arrangement can include the computing system 100 randomly determining a column identifier and a row identifier (from a set of remaining, unassigned column and row identifier combinations) for each of the predetermined symbols until there is only one remaining, unassigned column and row identifier. A last predetermined symbol would then be assigned to correspond to the one remaining, unassigned column and row identifier. As another example, selecting the symbol position for an embodiment in which the display arrangement is specified using symbol position identifiers (e.g., whole number 1 through 15, inclusive) can include the computing system 100 randomly determining a symbol position identifier (from a set of remaining, unassigned symbol position identifiers) for each of the predetermined symbols until there is only one remaining, unassigned symbol position identifier. A last predetermined symbol would then be assigned to correspond to the one remaining, unassigned symbol position identifier.

In accordance with embodiments in which a column and row arrangement is used to simulate reels, the computing system 100 can display each subset of selected symbols in a corresponding column. As an example, the computing system 100 can superimpose each subset of selected symbols over a virtual reel in a corresponding column. Thus, a sub-group 308, 309 can represent an ordering of symbols on a particular reel.

FIG. 10 also shows a trigger symbol table 316. The trigger symbol table 316 can include an identifier 318 of one or more symbols a processor uses to determine whether an event has been triggered. As an example, the identifier 318 can include the identifier 1001 discussed above as representing a particular symbol (e.g., a scatter symbol).

In accordance with at least some embodiments in which the global symbol group table 300 and the selected symbol set table 310 include data for a reel-based game, the global symbol group table 300 can include a respective sub-group for each reel of the reel-based game, and the selected symbol set table 310 can include a respective subset for each reel of the reel-based game. For example, in accordance with a reel-based game that displays reels in a GUI with N reel displays, the global symbol group table 300 can include N subgroups with multiple records 302 similar to the sub-group 308, 309. Moreover, the selected symbol set table 310 can include N subsets with multiple records 312 similar to the subsets 314, 315. For those examples, N can equal 2, 3, 4, 5, 6 or some other number equal to a number of reel displays used in a reel-based game.

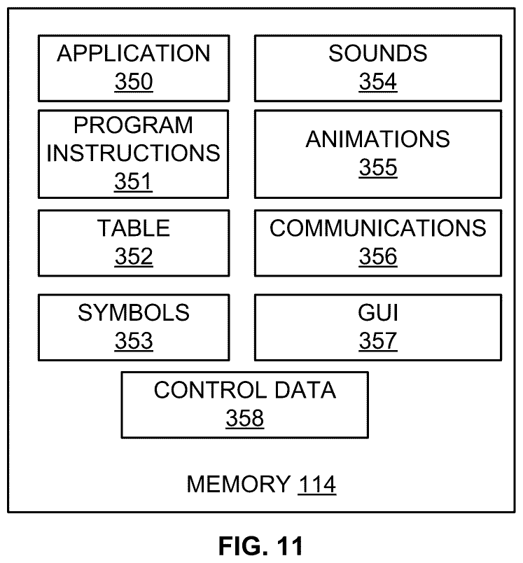

Next, FIG. 11 shows the memory 114 and data that can be stored in a memory in accordance with the example embodiments. The memory 114A, the memory 114B, and/or a memory 810 (shown in FIG. 19) can contain at least some of the data stored in the memory 114. In at least some embodiments, at least a portion of the memory 114 is embodied as a data register within a processor.

As shown in FIG. 11, the memory 114 can include one or more from among: an application 350, program instructions 351, a table 352, symbols 353, sounds 354, animations 355, communications 356, a GUI 357, or control data 358.

The application 350 can include a software application, such as any software application described in this description. The application 350 can also include an operating system, such as any operating system described in this description. The application 350 can include an application programming interface (API), such as any API described in this description.

The program instructions 351 are computer-readable program instructions (e.g., machine readable instructions) executable by one or more processors. The program instructions 351 can be executable to cause a computing system or a component of the computing system to perform any function described in this description. The program instructions 351 can include the application 350. The program instructions 351 can include and/or be arranged as one or more modules, such as any module shown in FIG. 19. The application 350 can include the program instructions 351. The program instructions 351 can include and/or be arranged as an algorithm to request one or more random numbers from an RNG (e.g., the RNG 115, 115A, 115B) and apply the random number(s) to determine an outcome for an instance of a game (e.g., a game with multiple jackpot states).

The table 352 can include one or more tables, such as one or more tables shown in FIG. 10. In at least some embodiments, the memory 114 can contain any data described as being stored in a table in some manner other than a table. As an example, the memory 114 can store program instructions that include data described as being contained in a table.

The symbols 353 can include computer-readable data a processor can read to generate a symbol on a display, a display screen, a graphical display unit, a graphical display interface, or a GUI. As an example, the symbols 353 can include a respective computer-readable file (e.g., a bitmap file) for each symbol. As another example, the symbols 353 can include a computer-readable file a processor can read to generate any symbol discussed in this description and/or shown in the drawings. A table, such as the symbol image table 304, can include an index value (e.g., a numerical identifier or a file name) corresponding to a symbol in the symbols 353.

The sounds 354 include audio files (e.g., an audio clip) that the processor 112 can output to a speaker. Outputting an audio file can include outputting a signal that produces a particular sound when the signal passes through a speaker. As an example, the particular sound can include a first particular sound to play when reels are spinning on the display 110B or a second particular sound to play when a trigger symbol has landed to indicate a jackpot value has been incremented or won. As another example, the sounds 354 can include an audio file, such as an audio file with one of the following file name extensions: WAV, MP3, MP4, WMA, or some other file name extension.

Each sound in the sounds 354 can correspond to an index value such that the processor 112A can provide the processor 112B with an instruction including a particular index value so that the processor 112B outputs via the speaker 111B an audio file corresponding to the particular index value. Accordingly, the processor 112A does not have to transmit the audio file to the processor 112B each time the audio file is to be output via the speaker 111B.

The animations 355 can include computer-readable files containing animations on a display, such as the display 110, 110A, 110B. As an example, the animations 355 can include animation files, such as an animation file with one of the following file name extensions: GIF, PNG, JPEG, SVG, or some other file name extension. Each animation in the animation 355 can correspond to an index value such that the processor 112A can provide the processor 112B with an instruction including a particular index value so that the processor 112B outputs via the display 110B an animation file corresponding to the particular index value. Accordingly, the processor 112A does not have to transmit the animation file to the processor 112B each time the animation file is to be output via the display 110B.

In at least some embodiment, an animation of the animations 355 is an entire graphical display (e.g., graphical user interface) output on display 110, 110A, 110B. In at least some other embodiments, an animation of the animations 355 is a portion of a graphical display output on display 110, 110A, 110B. Moreover, in at least some of those latter embodiments, multiple animations of the animations 355 are respective portions of a graphical display output on the display 110, 110A, 110B. As an example, a respective animation can be displayed within and/or as a reel display 229, 230, 231, 232, 233 shown in FIG. 12. As another example, an animation within a portion of a graphical display output on a display can include an animation to attract a potential player of a game and/or to distract a player of the game. A still image 234 of such an animation is shown in FIG. 12.

The communications 356 include one or more communications, such as one or more from among: a communication sent by the processor 112 coupled to the memory 114, a communication generated for transmitting by the processor 112 coupled to the memory 114, or a communication received by the computing system 100. As an example, for embodiments in which the communications 356 are stored in the memory 114A, the communications 356 can include a communication sent by the processor 112A to the computing system 100B, a communication generated for transmitting by the processor 112A coupled to the computing system 100B, or a communication received by the computing system 100A. As another example, for embodiments in which the communications 356 are stored in the memory 114B, the communications 356 can include a communication sent by the processor 112B to the computing system 100A, a communication generated for transmitting by the processor 112B coupled to the computing system 100B, or a communication received by the computing system 100B.

A processor can parse data from a communication stored in the communications 356 and write the parsed data into another part of the memory 114. For example, the processor can parse control data from within a communication and store the parsed control data into the control data 358.

The GUI 357 includes one or more GUIs displayable on a display (e.g., the display 110, 110A, 110B). The GUI 357 can include data to populate within a GUI. A GUI within the GUI 357 can be populated with other data stored in the memory 114. For example, a GUI within the GUI 357 can be populated with a symbol of the symbols 353, a sound within the sounds 354, an animation within the animations 355, or control data within the control data 358. Examples of a GUI storable within the GUI 357 are shown in FIG. 12 to FIG. 18.

The control data 358 can include data a processor uses to control performing instances of games having multiple jackpot states.

In at least some embodiments, the control data 358 includes first control data for a first set of jackpot states, such as a first set of jackpot states for a first win distribution. The first control data can include the following for each jackpot state of the first set of jackpot states: a rate of incrementing a jackpot state of the game, a rate of incrementing the jackpot state and awarding a jackpot prize, and a jackpot value. In at least some embodiments, the control data 358 also includes second control data for a second set of jackpot states, such as a second set of jackpot states for a second win distribution. The second control data can include the following for each jackpot state of the second set of jackpot states: a rate of incrementing a jackpot state of the game, a rate of incrementing the jackpot state and awarding a jackpot prize, and a jackpot value. The first control data is different than the second control data. The control data 358 can include additional control data for other win distributions.

In at least some embodiments, the control data 358 includes data regarding one or more players registered to play the game having multiple jackpot states. As an example, the control data 358 can include the following data for a player of the game: a user identifier, a password, two-factor authentication data, a credit balance, banking card information, and/or a state identifier indicating which jackpot state the player is currently playing or last played by the player before logging off the computing system.

The credit balance can represent a quantity of credits available for a user of a computing system to place bets on instance of the game having multiple jackpot states. A processor can update a respective credit balance for each user based on payments entered at a computing system by that user, awards earned by use of the computing system by that user, and/or by use of an acceptor and/or validator. The credit balance can be output on the display 110, 110a, 110b. The credit balance can be based upon a quantity of coins, tokens, and/or bills entered using an acceptor.

### IV. Example Graphical User Interfaces

Next, FIG. 12 to FIG. 15 show different views of a GUI 200 in accordance with the example embodiments. The GUI 200 includes a game symbol display segment 201. The game symbol display segment 201 includes a reel display 229, 230, 231, 232, 233 and a jackpot value indicator 235, 236, 237, 238, 239. The reel display 229, 230, 231, 232, 233 is configured to show a subset of symbols on a respective reel. In accordance with the GUI 200, the reel display 229, 233 shows three symbols of a respective reel, the reel display 230, 232 show four symbols of a respective reel, and the reel display 231 show five symbols of a respective reel. An animation of a reel spinning and then stopping can be displayed within the reel display 229, 230, 231, 232, 233 during performance of each instance of a game.

In accordance with at least some embodiments, the global symbol group table 300 can include a respective sub-group for a reel corresponding to the reel display 229, 230, 231, 232, 233 and the selected symbol set table 310 can include a respective subset for the reel corresponding to the reel display 229, 230, 231, 232, 233. The reel display 229, 230, 231, 232, 233 can be referred to as a column C1, C2, C3, C4, C5, respectively. The reel display 229, 233 includes three rows that can be referred to as row R1, R2, R3 (ordered from top to bottom). The reel display 230, 232 includes four rows that can be referred to as row R1, R2, R3, R4 (ordered from top to bottom). The reel display 231 includes five rows that can be referred to as row R1, R2, R3, R4, R5 (ordered from top to bottom).

The view of the GUI 200 in FIG. 12 shows the diamond symbol 220, the pair of cards symbol 221, the club symbol 222, the heart symbol 223, the cherry symbol 224, the dice symbol 225, and the E symbol 226. Some of those symbols are shown multiple times within the GUI 200 as shown in FIG. 12. The view of the GUI 200 in FIG. 12 also shows the still image 234 of an animation.

The GUI 200 includes a credit indicator 240 indicative of a quantity of credits available to a player. The processor can track that quantity of credits within the control data 358. The GUI 200 includes a bet indicator 241 indicative of a bet placed on an instance of a game with multiple jackpot states. The GUI 200 includes a user-selectable control 242 selectable to increase or decrease the bet before initiating performance of the instance of the game. The GUI 200 includes a win indicator 243 indicative of an amount of an award won during performance of a game with multiple jackpot states. The GUI 200 includes a free spins multiplier indicator 248 indicative of a multiplier for use to determine a quantity of free spins awarded by performance of the game having multiple jackpot states.

The GUI 200 includes a user-selectable control 244 selectable to initiate performance of a single instance of the game having multiple jackpot states. The GUI 200 includes a user-selectable control 245 selectable to initiate performance of multiple instances of the game having multiple jackpot states. The quantity of the multiple instances of the game can be indicated by an auto-play indicator 246 and a user-selectable control 247 to adjust the quantity of the multiple instances of the game. The user-selectable control 245 can be referred to as an auto-play USC.

The processor can perform an instance of the game in response to selection of the USC 244 or the USC 245. The processor can determine an outcome of the game and output the outcome of the game. As an example, the processor can determine that the outcome includes an award of $2.40 as a result of the reel display 229 displaying the diamond symbol 220. Outputting that portion of the outcome can include displaying an award indicator 249 in proximity to the reel display 229 or otherwise.

Determining the outcome of the game can include determining whether the reel display 229, 230, 231, 232, 233 includes symbols that indicate whether an increment jackpot or whether the jackpot corresponding to the jackpot value indicator 235, 236, 237, 238, 239, respectively has been won. If a jackpot state corresponding to a reel display is a penultimate state for a particular reel display and the jackpot trigger lands within the particular reel display, the processor can indicate that the jackpot triggers to the final jackpot state and a jackpot value corresponding to the final jackpot state has been won.

Next, FIG. 13 shows another view of the GUI 200. This view can be output after performance of a number of instances of the game as the credit indicator 240 indicates a different quantity of credits than shown in FIG. 12. The GUI 200 shows different selected sets of symbols in the reel display 229, 230, 231, 232, 233 including a jack symbol 227 and a king symbol 228 not shown in FIG. 12.

In FIG. 13, a jackpot value in the jackpot value indicator 235, 236, 237, 238, 239 is greater than a jackpot value in the jackpot value indicator 235, 236, 237, 238, 239 shown in FIG. 12. This represents that an increment jackpot trigger occurred for each reel display one or more times. For example, if the jackpot value increases by $1.00 for each increment jackpot trigger, than the increment trigger for the reel display 229, 230, 231, 232, 233 occurred one, two, seven, eleven, and three times, respectively, since the occurrence of the event represented in FIG. 12. Additionally, the free spins multiplier indicator 248 increased from 1× to 1.5× during the events performed between when the GUI 200 was shown as represented in FIG. 12 and when the GUI 200 was shown as represented in FIG. 13. The win indicator 243 indicates an award of $8.00 was won based on the symbols shown in the game symbol display segment 201 (e.g., the king symbol 228 landing four times in the reel display 231.

Next, FIG. 14 shows another view of the GUI 200. This view can be output in response to use of the USC 242 to increment the bet from $2.00 to $50.00. Modifying the bet by 25× results in modifying a jackpot value within the jackpot value indicator 235, 236, 237, 238, 239 by 25×.

Next, FIG. 15 shows another view of the GUI 200. This view indicates that some embodiments allow for wins based on paylines or payways that extend across two or more reel displays. As an example, FIG. 15 shows a payway 255 on which the diamond symbol 220 lands on four consecutive reel displays on the payway 255.

Next, FIG. 16 shows a GUI 400. The GUI 400 includes the same aspects as the GUI 200, except that the GUI 400 includes a single jackpot value indicator 237 rather than a jackpot indicator for each reel display (i.e., the GUI 400 does not include the jackpot value indicator 235, 236, 238, 239). In accordance with this embodiment, triggers to increment a jackpot state or to trigger a jackpot win can result from symbols in multiple different reels rather than just a single reel.

Next, FIG. 17 shows another view of the GUI 400. This view can be output after performance of a number of instances of the game as the credit indicator 240 indicates a different quantity of credits than shown in FIG. 16. The GUI 400 shows different selected sets of symbols in the reel display 229, 230, 231, 232, 233 compared to the selected sets of symbols shown in FIG. 16.

In FIG. 17, a jackpot value in the jackpot value indicator 237 is greater than a jackpot value in the jackpot value indicator 237 shown in FIG. 16. This represents that an increment jackpot trigger occurred within the game symbol display segment 201 one or more times. For example, if the jackpot value increases by $1.00 for each increment jackpot trigger, than the increment trigger within the game symbol display segment 201 occurred seven times since the occurrence of the event represented in FIG. 16. Additionally, the free spins multiplier indicator 248 increased from 1× to 1.5× during the events performed between when the GUI 400 was shown as represented in FIG. 16 and when the GUI 400 was shown as represented in FIG. 17. The win indicator 243 indicates an award of $8.00 was won based on the symbols shown in the game symbol display segment 201 (e.g., the king symbol 228 landing four times in the reel display 231.

Next, FIG. 18 shows another view of the GUI 400. This view can be output in response to use of the USC 242 to increment the bet from $2.00 to $50.00. Modifying the bet by 25× results in modifying a jackpot value within the jackpot value indicator 237 by 25×.

### V. Example Computing System

Next, FIG. 19 is a block diagram of a computing system 800 arranged for configuring a computing system to use particular jackpot states of a computer-implemented game in accordance with the example embodiments. The computing system 800 can include a computing platform 802 (e.g., one or more computing platforms). The computing platform 802 can be configured to communicate with a remote computing platform 804 (e.g., one or more remote platforms) according to a client/server architecture, a peer-to-peer architecture, and/or other architectures. The remote computing platform 804 can be configured to communicate with other remote platform(s) via the computing platform 802 and/or according to a client/server architecture, a peer-to-peer architecture, and/or other architectures. Users can access the computing system 800 directly or via the remote computing platform 804.

According to some embodiments, one or more of the computing platform 802, the remote computing platform 804, and/or other components of computing system 800 can be the same as or similar to one or more components of the computing system 100 of FIG. 8, the computing system 100a and/or the computing system 100b of FIG. 9, and/or other computing resources disclosed herein. The computing platform 802 can include a processor 808, a memory 810, a communication interface 812, a user interface 814, and/or the power system 52. The processor 808 can include and/or be arranged like the processor 112, 112A, 112B. The memory 810 can include and/or be arranged like the memory 114, 114A, 114B. The communication interface 812 can include and/or be arranged like the communication interface 102, 102A, 102B. The user interface 814 can include and/or be arranged like the user interface 104, 104A, 104B.

The computing platform 802 can include the power system 52. A power circuit 816 can connect the power system 52 to the processor 808, the memory 810, the communication interface 812, and/or the user interface 814. The power circuit 816 can connect to components of the processor 808, the memory 810, the communication interface 812 (e.g., components of the communication interface 102, 102A, 102B), and/or the user interface 814 (e.g., components of the user interface 104, 104A, 104B).

The computing platform 802 can be configured by machine-readable instructions 818 (i.e., computer-readable program instructions). The machine-readable instructions 818 can include one or more instruction modules. The instruction modules can include computer program modules. The instruction modules can include one or more of a configuration module 820, a provide USC module 822, a perform instance of game module 824, a determine outcome of game module 826, an output outcome of game module 828, a provide control data module 830, a select win distribution module 832, a change power state module 834, a perform reset module 836, a log player on/off module 838, an execute interrupt module 840, an output GUI module 842, and/or other instruction module(s). A processor 808 can be configured to execute any instruction module, any portion of the machine-readable instructions 818, or all of the machine-readable instructions 818. The remote computing platform 804 can included the machine-readable instructions 818.

### A. Configuration Module

The configuration module 820 can be arranged to configure a computing system, such as the computing system 100, 100A, 100B, 800 to operate using a particular jackpot state for a game including multiple jackpot states. Configuring the computing system 100, 100A, 100B, 800 to operate using the particular jackpot state for the game can include configuring the computing platform 802 to operate using the particular jackpot state for the game.

As an example, the configuration module 820 can be arranged to configure the computing system to operate using a first jackpot state for a game with multiple jackpot states. As another example, the configuration module 820 can be arranged to configure the computing system to operate using the second jackpot state for a second instance of the game.

In accordance with at least some embodiments, the game including multiple jackpot states includes more than one thousand jackpot states. In that regard, the configuration module 820 can be arranged to configure the computing system to operate using each of the more than one thousand jackpot states.

In accordance with at least some embodiments, the game including multiple jackpot states includes between three and one thousand jackpot states. In that regard, the configuration module 820 can be arranged to configure the computing system to operate using each of the between three and one thousand jackpot states.

In accordance with at least some embodiments, the game including multiple jackpot states defined by the control data 358, such as the first control data and the second control data described above. As an example, the first control data can include the data within a row of Table 2 other than the final row, and the second control data can include the data within a row of Table 2 other than the first row.

In accordance with at least some embodiments, the configuration module 820 and/or another portion of the computing system 800 can keep track of which jackpot state is a current jackpot state for the game. In accordance with at least some embodiments, the control data 358 can include data indicative of the current jackpot state. As an example, for an embodiment in which the game includes N jackpot states, the N jackpot states can be represented sequentially by hexadecimal numbers from 1 to N. For instance, if the game includes 1,000 jackpot states, the control data 358 can include three bytes of data to represent the jackpot states using values 0000 0000 0001 for jackpot state 1 to 0011 1110 1000 for jackpot state 1,000. In at least some embodiments, the configuration module 820 can increment the value within the three bytes by a value of 1 when incrementing the jackpot state. In at least some embodiments, the configuration module 820 can set the value within the three bytes to a value of 0000 0000 0001 after a jackpot prize has been awarded.

The current jackpot state is jackpot state among a quantity of multiple jackpot states arranged in a sequence of jackpot states beginning at an initial jackpot state and ending at a final jackpot state. The sequence of jackpot states includes a penultimate jackpot state immediately before the final jackpot state. In at least some embodiments, the first jackpot state is the initial jackpot state. In at least some other embodiments, the first jackpot state is an intermediate jackpot state between the initial jackpot state and the final jackpot state.

In accordance with at least some embodiments, the configuration module 820 is configured to configure the computing system to operate using the first jackpot state (e.g., the initial jackpot state) occurs in response to completing a prior instance of the game during which a jackpot prize was awarded.

In accordance with at least some embodiments, the game can include a separate jackpot state for each reel of a set of multiple reels. In that regard, the control data 358 can include data indicative of the current jackpot state for each reel of the set of multiple reels. In that regard, identifiers (e.g., numeric identifiers) corresponding to the current jackpot state of two or more reels can be identical for one or more instances of the game. Additionally, identifiers (e.g., numeric identifiers) corresponding to the current jackpot state of two or more reels can be different for one or more instances of the game. Furthermore, in some embodiments, the quantity of jackpot states corresponding to each reel is identical, whereas in other embodiments the quantifies of jackpot states corresponding to two or more reels are different.

In accordance with at least some embodiments, a jackpot value corresponding to each jackpot state in the sequence of jackpot states increases from a minimum jackpot value corresponding to the initial jackpot state up to a maximum jackpot value corresponding to the final jackpot state. In accordance with at least some of those embodiments, the jackpot values increase linearly as a jackpot state of the game increments from the initial jackpot state to the final jackpot state.

### B. Provide USC Module

The provide USC module 822 can be configured to provide, at a user interface of the computing system, a USC to initiate each instance of the game. In at least some embodiments, the USC initiates one instance of the game each time the USC is used. In at least some embodiments, the USC initiates multiple instances of the game each time the USC is used.

In accordance with at least some embodiments, providing the USC includes providing, at the computing system, a software interrupt and a graphical user interface including a virtual button. The processor 808 can execute the software interrupt in response to respective selections of the virtual button to initiate each instance of the game. As an example, the virtual button can be arranged like the USC 244 and/or the USC 245 shown in FIG. 12 to FIG. 18.

In accordance with at least some embodiments, providing the USC includes providing a hardware button, circuitry connecting the hardware button to a processor, and a software interrupt. The processor 808 can execute the software interrupt in response to respective selections of the hardware button to initiate each instance of the game.

In accordance with at least some embodiments, providing the USC to initiate each instance of the game includes a first USC and a second USC. The first USC is configured to initiate one instance of the game for each use of the first USC. The second USC is configured to initiate auto-play of two or more instances of the game for each use of the second USC. As an example, the first USC and the second USC can include hardware USCs, such as hardware buttons of the USC 109 shown in FIG. 8.

In accordance with at least some embodiments, providing the USC to initiate an instance of the game includes outputting, within a GUI, an icon corresponding to the USC to initiate the instance of the game. The icon is mapped to a particular location within the GUI.

### C. Perform Instance of Game Module

The perform instance of game module 824 can be configured to perform, in response to selection of the USC (e.g., the USC 244 or the USC 245), each instance of the game while the computing system operates using a current jackpot state.

For example, the perform instance of game module 824 can be configured to perform, in response to selection of the USC, one or more instances (e.g., a first instance) of the game while the computing system operates using a first jackpot state of a first set of jackpot states. As another example, the perform instance of game module 824 can be configured to perform, in response to selection of the USC, one or more instances (e.g., a second instance) of the game while the computing system operates using a second jackpot state of a first set of jackpot states. As yet another example, the perform instance of game module 824 can be configured to perform, in response to selection of the USC, one or more instances (e.g., a third instance) of the game while the computing system operates using a first jackpot state of a second set of jackpot states. As still yet another example, the perform instance of game module 824 can be configured to perform, in response to selection of the USC, one or more instances (e.g., a fourth instance) of the game while the computing system operates using a second jackpot state of a second set of jackpot states.

In accordance with at least some embodiments, the game comprises a reel-based game including one or more virtual reels. A first virtual reel of the one or more virtual reels corresponds to a first set of symbols. A first subset of symbols from the first set of symbols is selected to represent the outcome of the first instance of the game. A second subset of symbols from the first set of symbols is selected to represent the outcome of the second instance of the game.

In accordance with at least some embodiments such as at least some of the embodiments discussed in the preceding paragraph, the first subset of symbols matches the second subset of symbols, and an order of all symbols within the first subset of symbols matches an order of all symbols within the second subset of symbols. Accordingly, in accordance with at least some embodiments, matching subsets of symbols can be displayed for different instances of the game.

In accordance with at least some embodiments, a virtual button is output within a GUI and the virtual button corresponds to a particular area within the GUI. The processor 808 can execute a software interrupt (e.g., the execute interrupt module 840) in response to respective selections of the virtual button to initiate each instance of the game. As an example, selection of the virtual button can occur via contact with the display at the particular area or via use of a pointing device while pointing to the particular area.

In accordance with at least some embodiments, using the current jackpot state includes the perform instance of game module 824 multiplying one or more jackpot values within control data based on an amount of a bet placed for the current instance of the game. For example, using the first jackpot state for the first instance of the game includes multiplying one or more jackpot values within the first control data based on an amount of a bet placed for the first instance of the game. As another example, using the second jackpot state for the second instance of the game includes multiplying one or more jackpot values within the first control data based on an amount of a bet placed for the second instance of the game.

### D. Determine Outcome of Game Module

The determine outcome of game module 826 can be configured to determine an outcome for each instance of the game. For example, the determine outcome of game module 826 can be configured to determine an outcome of the first instance of the game, an outcome of the second instance of the game, an outcome of the third instance of the game, a fourth instance of the second instance of the game, and so on for each additional instance of the game.

The outcome of the first instance of the game (or another instance of the game) can include an outcome to change from the first jackpot state to a second jackpot state.

As an example, an outcome for each instance of the game can include one of the following outcomes: a no effect on jackpot outcome, an increment jackpot outcome, or an increment and award jackpot outcome.

In accordance with the example discussed in the preceding paragraph, a probability corresponding to the no effect on jackpot outcome is

$${p}_{x}^{n} ,$$

a probability corresponding to the increment jackpot outcome is

$${p}_{i}^{n} ,$$

and a probability corresponding to the increment and award jackpot outcome is

$${p}_{t}^{n} .$$

### Moreover,

$${p}_{x}^{n} + {p}_{i}^{n} + {p}_{t}^{n} = 1 ,$$

and n corresponds to a current jackpot state the computing system is configured to use.

In accordance with at least some of the examples discussed in the two preceding paragraphs, the computing system is configured such that a maximum jackpot value is output in response to the increment and award jackpot outcome being achieved during an instance of the game while the computing system is configured to operate using the penultimate jackpot state.

In accordance with at least some of the examples discussed in the three preceding paragraphs, the computing system is configured such that the probability

$${p}_{i}^{n}$$

for each instance of the game while the computing system is configured to operate using the penultimate jackpot state is zero.

In accordance with at least some of the examples discussed in the four preceding paragraphs, the computing system is configured such that a jackpot value corresponding to the initial jackpot state is never awarded.

In accordance with at least some of the examples discussed in the five preceding paragraphs, the probability

$${p}_{t}^{n}$$

equals RTP/v. In that regard, v equals a jackpot value corresponding to the current jackpot state the computing system is configured to use and RTP equals a return-to-player value selected for the game.

In accordance with embodiments in which the determine outcome of game module 826 determines an outcome of a second instance of the game, the determine outcome of game module 826 can determine the computing system is to continue operating using the second jackpot state for a next instance of the game (e.g., no effect on jackpot outcome).

In accordance with embodiments in which the determine outcome of game module 826 determines, for an instance of the game, an outcome that includes a monetary award less than a jackpot value defined for the multiple jackpot states and a wager placed on the instance of the game.

In accordance with embodiments in which the multiple jackpot states include a sequence of jackpot states beginning at an initial jackpot state and ending at a final jackpot state and the sequence of jackpot states includes a penultimate jackpot state immediately before the final jackpot state, determining the outcome of the second instance of the game includes determining the computing system is to increment to a third jackpot state for a next instance of the game and the third jackpot state includes an intermediate jackpot state between the second jackpot state and the final jackpot state.

In accordance with embodiments in which the multiple jackpot states include a sequence of jackpot states beginning at an initial jackpot state and ending at a final jackpot state, the sequence of jackpot states includes a penultimate jackpot state immediately before the final jackpot state, and the second jackpot state is the penultimate jackpot state, determining the outcome of the second instance of the game includes determining the computing system is to increment to the final jackpot state. Additionally, outputting the outcome of the second instance of the game includes outputting an indication that a jackpot value corresponding to the final jackpot state has been awarded. The output outcome of game module 828 can be configured to output that outcome of the second instance of the game.

In accordance with embodiments in which the multiple jackpot states include a sequence of jackpot states beginning at an initial jackpot state and ending at a final jackpot state and the sequence of jackpot states includes a penultimate jackpot state immediately before the final jackpot state, the jackpot value corresponding to the final jackpot state is a maximum jackpot value defined for the multiple jackpot states.

In accordance with embodiments in which the multiple jackpot states include a sequence of jackpot states beginning at an initial jackpot state and ending at a final jackpot state and the sequence of jackpot states includes a penultimate jackpot state immediately before the final jackpot state, a distribution of wins over the multiple jackpot states is defined for the game. The select win distribution module 832 can be configured to select that wins distribution.

In accordance with embodiments in which the multiple jackpot states include a sequence of jackpot states beginning at an initial jackpot state and ending at a final jackpot state and the sequence of jackpot states includes a penultimate jackpot state immediately before the final jackpot state, the multiple states include between three and one thousand states.

In accordance with embodiments in which the multiple jackpot states include a sequence of jackpot states beginning at an initial jackpot state and ending at a final jackpot state and the sequence of jackpot states includes a penultimate jackpot state immediately before the final jackpot state, the multiples states include more than one thousand states.

Execution of the determine outcome of game module 826 can include a processor using a random number generator (e.g., the RNG 115, 115A, 115B) to determine a set of symbols to output on the display. In accordance with at least some embodiments, the processor uses multiple random number generators to determine a respective set of symbols for each of two or more reels. In accordance with at least some embodiments, the determine outcome of game module 826 can receive random numbers from an RNG to determine an outcome of a game based on data that corresponds to an outcome type, such as the data shown in Table 1, and other random numbers to determine symbols to display on one or more virtual reels to represent an outcome of the game.

For example, for an implementation in which an overlay symbol is used to show an outcome with a triggered jackpot, at least one RNG result can be used to determine one of three outcome types for the game. Additionally, for an implementation in which there are five different jackpots, one per reel, the computing system can use five additional RNG results to determine the result and impact on each of the five jackpots. As another example, a user can press a USC to spin the reels on the computing device 100B, and the computing device 100B can send a request to the computing device 100A. The processor 112A can request five different RNG results from the RNG 115A, one for each of the reels. The processor 112A can five further RNGs results, one for each of the jackpot changes. These RNG results are then mapped by the processor 112A to represent the result of the game (e.g., one RNG result mapped for each of the reel results, and one RNG result for each of the five jackpot changes).

In accordance with at least some embodiments, the determine outcome of game module 826 requests an RNG to provide random numbers to determine an outcome type and symbols for each of the three outcome types. The processor 808 can use the symbols for the determined outcome type when outputting an outcome of the game using the output outcome of game module 828. Afterwards, the processor 808 can determine symbols to represent the outcome based on the random numbers generated for the determined outcome type.

In accordance with at least some other embodiments, the determine outcome of game module 826 requests an RNG to provide a random number indicative of an outcome type for an instance of the game and then requests the RNG to provide random numbers to determine symbols to represent an outcome based on the determined outcome type for the instance of the game. An advantage of these embodiments is that fewer random numbers are required since the processor doesn't need random numbers for each of the three outcome types.

### E. Output Outcome of Game Module

The output outcome of game module 828 can be configured to output, on a display of the computing system, an outcome of the each instance of the game. For instance, the output outcome of game module 828 can output a first instance of the game, a second instance of the game, a third instance of the game, a fourth instance of the game and/or one or more other instances of the game.

In accordance with at least some embodiments, such as embodiments in which a separate set of jackpot states corresponds to each reel of multiple displayed reels, outputting the outcome of the first instance of the game includes displaying, on the display, a first subset of symbols corresponding to a first virtual reel, and outputting the outcome of the second instance of the game includes displaying, on the display, a second subset of symbols corresponding to the first virtual reel. The first jackpot state and the second jackpot state correspond to outcomes of the game shown on the first virtual reel.

In accordance with at least some embodiments, such as embodiments in which a single set of jackpot states corresponds to all reels of multiple displayed reels, outputting the outcome of the first instance of the game includes displaying, on the display, first subsets of symbols, each first subset of symbols corresponding to a respective one virtual reel of a set of virtual reels, and outputting the outcome of the second instance of the game includes displaying, on the display, second subsets of symbols, each second subset of symbols corresponding to the respective one virtual reel of the set of virtual reels. The first jackpot state and the second jackpot state correspond to outcomes of the game shown on the set of virtual reels.

In accordance with at least some embodiments, outputting the outcome of an instance of the game includes outputting the outcome of the instance of the game within a GUI.

In accordance with at least some embodiments, outputting the outcome of an instance of the game includes displaying a respective set of symbols determined for each reel of multiple reels. Additionally, outputting the outcome of the instance of the game includes displaying an indication of which reel, payline, or payway resulted in a win and an award won for that reel, payline, or payway.

In accordance with at least some embodiments, outputting the outcome of an instance of the game includes displaying an indication that the prize pot increased.

In accordance with at least some embodiments, outputting the outcome of an instance of the game includes displaying an indication that the prize pot was won.

### F. Provide Control Data Module

The provide control data module 830 can be configured to provide the computing system with control data. As an example, the provide control data module 830 can be configured to receive control data from the remote computing platform 804 and/or the external resources. As another example, the computing platform 802 can receive the control data via the communication interface 812 and/or the user interface 814. The processor 808 can write the control data into the memory 810 by the processor 808. The processor 808 can provide the control data to the configuration module 820 for use in configuring the computing system 800 and/or the computing platform 802.

The provide control data module 830 can be configured to provide the computing system with control data based on a probability distribution and/or win distribution selected to be used for game. For example, the provide control data module 830 can be configured to provide the computing system with first control data corresponding to a first win distribution, such as a normal win distribution, second control data corresponding to a second win distribution, such as a uniform win distribution, and/or third control data corresponding to a third win distribution, such as a log-normal win distribution.

In accordance with at least some embodiments, the first control data includes the following control data for each jackpot state of a first set of jackpot states (e.g., a set of jackpot states corresponding to a first win distribution): a rate of incrementing a jackpot state of the game, a rate of incrementing the jackpot state and awarding a jackpot prize, and a jackpot value. Similarly, the second control data includes the following control data for each jackpot state of a second set of jackpot states (e.g., a set of jackpot states corresponding to a second win distribution): a rate of incrementing a jackpot state of the game, a rate of incrementing the jackpot state and awarding a jackpot prize, and a jackpot value. Likewise, the third control data includes the following control data for each jackpot state of a third set of jackpot states (e.g., a set of jackpot states corresponding to a third win distribution): a rate of incrementing a jackpot state of the game, a rate of incrementing the jackpot state and awarding a jackpot prize, and a jackpot value. Additional control data can be provided for each jackpot state of a further set of jackpot states (e.g., a set of jackpot states corresponding to a further win distribution).

In accordance with at least some embodiments, the first control data is based on a first probability density function, the second control data is based on a second probability density function, and the first probability density function is different than the second probability density function. As an example, the first probability density function or the second probability density function defines a uniform win distribution, a normal win distribution, or a log-normal win distribution.

In accordance with at least some embodiments, a quantity of jackpot states for two or more control data are the same. For instance, the first set of jackpot states corresponding to the first control data and the second set of jackpot states corresponding to the second control data can have an identical quantity of jackpot states. In accordance with at least some other embodiments, a quantity of jackpot states for two or more control data are different. For instance, the first set of jackpot states corresponding to the first control data and the second set of jackpot states corresponding to the second control data are different quantities of jackpot states.

In accordance with this example, the configuration module 820 can be arranged such that configuring the computing system to operate using the first jackpot state includes providing a random number generator with a request based on the first control data for the first jackpot state, and configuring the computing system to operate using the second jackpot state includes providing the random number generator with a request based on the first control data for the second jackpot state.

In accordance with at least some embodiments, a user-selectable control is provided to alter a wager for the first instance of the game, and the computing system alters a jackpot value based on the wager for the first instance of the game. The control data 258 can include data that indicates the amount of the wager and/or the jackpot value based on the wager.

### G. Select Win Distribution Module

The select win distribution module 832 can be configured to select a win distribution defined for the game. The win distribution can be defined for a quantity of jackpot states for the game. As an example, the quantity of jackpot states can include more than one thousand jackpot states. As another example the quantity of jackpot states can include up to one thousand jackpot states.

As an example, the select win distribution module 832 can be configured to select a first win distribution defined for the game. The first win distribution prescribes multiple jackpot states for the game. As an example, the first win distribution comprises a uniform win distribution (such as the uniform distribution represented in FIG. 3), a normal win distribution (such as the normal distribution represented in FIG. 5), or a log-normal win distribution (such as the log-normal distribution represented in FIG. 6). In another example, the first win distribution or another win distribution defined for the game can include a linear win distribution, a polynomial win distribution, a sine win distribution, a sinc win distribution, or a custom win distribution.

As another example, the select win distribution module 832 can be configured to select a second win distribution defined for the game. The second win distribution is different than the first win distribution. If the first win distribution comprises the uniform win distribution, then the second win distribution can comprise the normal win distribution, the log-normal win distribution, or another win distribution. If the first win distribution comprises the normal win distribution, then the second win distribution can comprise the uniform win distribution, the log-normal win distribution, or another win distribution. If the first win distribution comprises the log-normal win distribution, then the second win distribution can comprise the uniform win distribution, the normal win distribution, or another win distribution.

In accordance with at least some embodiments, the select win distribution module 832 is configured to select the select the second win distribution after a jackpot prize is awarded while the computing system is configured to use the first win distribution such that a next instance of the game is performed with the computing system configured to use the second win distribution.

The selected win distribution with the quantity of jackpot states discussed above can include a sequence of jackpot states beginning at an initial jackpot state and ending at a final jackpot state. The sequence of jackpot states includes a penultimate jackpot state immediately before the final jackpot state. In at least some embodiments, the first jackpot state is the initial jackpot state.

### H. Change Power State Module

The change power state module 834 can be configured to execute in response to the power system 52 receiving electrical power from an external power source while the power system 52 was in an off state. As an example, receiving the electrical power from the external power source while the power system 52 was in the off state can occur in response to use of a power switch at the computing system 800.

In accordance with at least some embodiments, change power state module 834 is executed the first time the computing system 800 and/or the computing platform 802 is powered on. In accordance at least some of those embodiments, the first jackpot state comprises an initial jackpot state of a sequence of jackpot states ending with a final jackpot state, and configuring the computing system to operate using the first jackpot state occurs in response to the computing system 800 and/or the computing platform 802 powering on for the first time.

### I. Perform Reset Module

The perform reset module 836 can be configured to perform a software reset. In accordance with at least some embodiments, performing the software reset can include rebooting or restarting the computing system and/or an application on the computing system. In accordance with at least some embodiments, performing the software reset can include configuring the computing system to operate using an initial jackpot state of a sequence of jackpot states that ends with a final jackpot state. In accordance with at least some other embodiments, performing the software reset can include the communication interface 812 requesting control data corresponding to a current player and a current jackpot state tracked in the control data 358 for the currently player, and configuring the computing system to use the current jackpot state indicated by the control data 358.

J. Log Player on/Off Module

The log player on/off module 838 can be configured to log a player onto a computing system or log the player off of the computing system. The log player on/off module 838 can be configured as an application programing interface (API) to allow a player to enter a user identifier, a password, and/or two-factor authentication information. The log player on/off module 838 can authenticate a user attempting to log onto the computing system. The log player on/off module 838 can use the communication interface 812 to communicate with the remote computing platform 804 and/or the external resources 806 to authenticate a player attempting to log onto the computing system 800.

In accordance with at least some embodiments, the first jackpot state comprises an initial jackpot state of a sequence of jackpot states ending with a final jackpot state, and configuring the computing system to operate using the first jackpot state occurs in response to a new player logging onto the computing system to play the game for an initial time.

In accordance with at least some embodiments, the first jackpot state comprises an intermediate state between an initial jackpot state of a sequence of jackpot states ending with a final jackpot state, and configuring the computing system to operate using the first jackpot state occurs in response to a prior player logging onto the computing system via the log player on/off module 838 and the computing system 800 determining the prior player ended a prior session of playing the game having multiple jackpot states in the first jackpot state.

### K. Execute Interrupt Module

The execute interrupt module 840 can be configured to execute interrupt instructions programmed into the machine-readable instructions 818. A software or hardware trigger can interrupt execution of other machine-readable instructions so that the interrupt instructions can be executed.

As an example, the execute interrupt module 840 can be configured to execute the software interrupt in response to respective selections of the virtual button to initiate each instance of the game. In at least some embodiments, the virtual button can be arranged like the user-selectable control 244 or the user-selectable control 245 shown in FIG. 12 to FIG. 18.

As another example, the execute interrupt module 840 can be configured to execute the software interrupt in response to respective selections of a hardware button to initiate each instance of the game. In at least some embodiments, the hardware button can be arranged like a hardware button of the user-selectable control 109 shown in FIG. 8.

### L. Output GUI Module

The output GUI module 842 can be configured to output a GUI to the user interface 814 and/or to a component of the user interface 814 (e.g., a display such as the display 110). As an example, the output GUI module 842 can include and/or interface to a graphics card and/or a graphics driver, such as a graphics card and/or graphics driver provided by INTEL®, NVIDIA®, or AMD ADVANTAGE®.

Outputting the GUI to a display includes visually presenting the GUI via the display. Outputting the GUI can include outputting a sound of the sounds of the sounds 354 to a speaker, such as the speaker 111.

As an example, the output GUI module 842 can be configured to output a GUI, such as the GUI 200 shown in FIG. 12 to FIG. 15 and/or the GUI 400 shown in FIG. 16 to FIG. 18.

In accordance with at least some embodiments, the output GUI module 842 is configured to output a GUI on the display, such that providing the user-selectable control by the provide USC module 822 includes outputting a virtual button within the GUI. The virtual button corresponds to a particular area within the GUI.

### VI. Example Method

Next, FIG. 20 is a flow chart showing a set 900 of functions that can be carried out using the computing system 100 of FIG. 8, the computing system 100a and/or the computing system 100b shown in FIG. 9, the computing system 800 shown in FIG. 19, the computing platform 802 shown in FIG. 19, the remote computing platform 804 shown in FIG. 19, other external resources 806, or some other computing system. A method of the example embodiments can include performing one or more functions of the set 900 and/or a portion of one or more functions of the set 900. Additionally, the order in which the functions of set 900 are illustrated in FIG. 20 and described below is not intended to be limiting.

Accordingly, a method based on one or more functions of the set 900 can include a computer-implemented method that includes the computing system 800 and/or the computing platform 802 executing a software application of the computing system 800, the computing platform 802, the remote computing platform 804, and/or other computing resources with and/or in communication with a display screen.

In at least some implementations, the software application includes the machine-readable instructions 818 or a portion thereof, such as the configuration module 820, the provide USC module 822, the perform instance of game module 824, the determine outcome of game module 826, the output outcome of game module 828, the provide control data module 830, the select win distribution module 832, the change power state module 834, the perform reset module 836, the log player on/off module 838, the execute interrupt module 840, the output GUI module 842, and/or other instruction module(s). In at least some implementations, execution of the software application includes graphically displaying, on symbol display segments of the display screen, animations that simulate spinning a plurality of reels. A memory (e.g., the memory 114, the memory 114A, the memory 114B, the memory 810, and/or one or more other memories) can store, a global symbol group including a plurality of symbols. Subsets of the global symbol group and/or the plurality of symbols are displayable in a respective layouts output onto the display screen.

Block 901 includes configuring a computing system to operate using a first jackpot state for a game with multiple jackpot states. The function(s) of block 901 can be performed by a processor (e.g., one or more hardware processors) configured by machine-readable instructions including a module that is the same as or similar to the configuration module 820, in accordance with the example embodiments. The functions of block 901 can include one or more of the functions described with respect to the configuration module 820. As an example, the processor can configure a computing system to operate using a first jackpot state for a game with multiple jackpot states with the configuration module 820 shown in FIG. 19.

Next, block 902 includes providing, at a user interface of the computing system, a user-selectable control to initiate each instance of the game. The function(s) of block 902 can be performed by a processor (e.g., one or more hardware processors) configured by machine-readable instructions including a module that is the same as or similar to the provide USC module 822, in accordance with the example embodiments. The functions of block 902 can include one or more of the functions described with respect to the provide USC module 822. As an example, the processor can provide, at a user interface of the computing system, a user-selectable control to initiate each instance of the game with the provide USC module 822 shown in FIG. 19.

Next, block 903 includes performing, in response to selection of the user-selectable control, a first instance of the game while the computing system operates using the first jackpot state. The function(s) of block 903 can be performed by a processor (e.g., one or more hardware processors) configured by machine-readable instructions including a module that is the same as or similar to the perform instance of game module 824, in accordance with the example embodiments. The functions of block 903 can include one or more of the functions described with respect to the perform instance of game module 824. As an example, the processor can perform, in response to selection of the user-selectable control, a first instance of the game while the computing system operates using the first jackpot state with the perform instance of game module 824 shown in FIG. 19.

Next, block 904 includes determining, an outcome of the first instance of the game, wherein the outcome of the first instance of the game includes an outcome to change from the first jackpot state to a second jackpot state. The function(s) of block 904 can be performed by a processor (e.g., one or more hardware processors) configured by machine-readable instructions including a module that is the same as or similar to the determine outcome of game module 826 in accordance with the example embodiments. The functions of block 904 can include one or more of the functions described with respect to the determine outcome of game module 826. As an example, the processor can determine, an outcome of the first instance of the game, wherein the outcome of the first instance of the game includes an outcome to change from the first jackpot state to a second jackpot state with the determine outcome of game module 826 shown in FIG. 19.

Next, block 905 includes outputting, on a display of the computing system, an outcome of the first instance of the game. The function(s) of block 905 can be performed by a processor (e.g., one or more hardware processors) configured by machine-readable instructions including a module that is the same as or similar to the output outcome of game module 828, in accordance with the example embodiments. The functions of block 905 can include one or more of the functions described with respect to the output outcome of game module 828. As an example, the processor can output, on a display of the computing system, an outcome of the first instance of the game with the output outcome of game module 828 shown in FIG. 19.

Next, block 906 includes configuring the computing system to operate using the second jackpot state for a second instance of the game. The function(s) of block 906 can be performed by a processor (e.g., one or more hardware processors) configured by machine-readable instructions including a module that is the same as or similar to the configuration module 820, in accordance with the example embodiments. The functions of block 906 can include one or more of the functions described with respect to the configuration module 820. As an example, the processor can configure the computing system to operate using the second jackpot state for a second instance of the game with the configuration module 820 shown in FIG. 19.

Next, block 907 includes performing, in response to selection of the user-selectable control, the second instance of the game while the computing system operates using the second jackpot state. The function(s) of block 907 can be performed by a processor (e.g., one or more hardware processors) configured by machine-readable instructions including a module that is the same as or similar to the perform instance of game module 824, in accordance with the example embodiments. The functions of block 907 can include one or more of the functions described with respect to the perform instance of game module 824. As an example, the processor can perform, in response to selection of the user-selectable control, the second instance of the game while the computing system operates using the second jackpot state with the perform instance of game module 824 shown in FIG. 19.

Next, block 908 includes determining an outcome of the second instance of the game. The function(s) of block 908 can be performed by a processor (e.g., one or more hardware processors) configured by machine-readable instructions including a module that is the same as or similar to the determine outcome of game module 826, in accordance with the example embodiments. The functions of block 908 can include one or more of the functions described with respect to the determine outcome of game module 826. As an example, the processor can determine an outcome of the second instance of the game with the determine outcome of game module 826 shown in FIG. 19.

Next, block 909 includes outputting, on the display of the computing system, the outcome of the second instance of the game. The function(s) of block 909 can be performed by a processor (e.g., one or more hardware processors) configured by machine-readable instructions including a module that is the same as or similar to the output outcome of game module 828, in accordance with the example embodiments. The functions of block 909 can include one or more of the functions described with respect to the output outcome of game module 828. As an example, the processor can output, on the display of the computing system, the outcome of the second instance of the game with the output outcome of game module 828 shown in FIG. 19.

Next, FIG. 21 shows a set 910 of functions. The set 910 includes functions shown in block 911. In accordance with the example embodiments, a method including one or more functions of the set 900 can include performing a function corresponding to block 911.

Block 911 includes providing the computing system with control data. The function(s) of block 911 can be performed by a processor (e.g., one or more hardware processors) configured by machine-readable instructions including a module that is the same as or similar to the provide control data module 830, in accordance with the example embodiments. The functions of block 911 can include one or more of the functions described with respect to the provide control data module 830. As an example, the processor can provide the computing system with control data with the provide control data module 830 shown in FIG. 19.

Next, FIG. 22 shows a set 920 of functions. The set 920 includes functions shown in block 921. In accordance with the example embodiments, a method including one or more functions of the set 900 and/or the set 910 can include performing a function corresponding to block 921.

Block 921 includes selecting a win distribution. The function(s) of block 921 can be performed by a processor (e.g., one or more hardware processors) configured by machine-readable instructions including a module that is the same as or similar to the select win distribution module 832, in accordance with the example embodiments. The functions of block 921 can include one or more of the functions described with respect to the select win distribution module 832. As an example, the processor can select a win distribution with the select win distribution module 832 shown in FIG. 19.

Next, FIG. 23 shows a set 930 of functions. The set 930 includes functions shown in block 931. In accordance with the example embodiments, a method including one or more functions of the set 900, the set 910, and/or the set 920 can include performing a function corresponding to block 931.

Block 931 includes changing a power state. The function(s) of block 931 can be performed by a processor (e.g., one or more hardware processors) configured by machine-readable instructions including a module that is the same as or similar to the change power state module 834, in accordance with the example embodiments. The functions of block 931 can include one or more of the functions described with respect to the change power state module 834. As an example, the processor can change a power state with the change power state module 834 shown in FIG. 19.

Next, FIG. 24 shows a set 940 of functions. The set 940 includes functions shown in block 941. In accordance with the example embodiments, a method including one or more functions of the set 900, the set 910, the set 920, and/or the set 930 can include performing a function corresponding to block 941.

Block 941 includes performing a reset. The function(s) of block 941 can be performed by a processor (e.g., one or more hardware processors) configured by machine-readable instructions including a module that is the same as or similar to the perform reset module 836, in accordance with the example embodiments. The functions of block 941 can include one or more of the functions described with respect to the perform reset module 836. As an example, the processor can perform a reset with the perform reset module 836 shown in FIG. 19.

Next, FIG. 25 shows a set 950 of functions. The set 950 includes functions shown in block 951. In accordance with the example embodiments, a method including one or more functions of the set 900 the set 910, the set 920, the set 930, and/or the set 940 can include performing a function corresponding to block 951.

Block 951 includes logging a player on or off. The function(s) of block 951 can be performed by a processor (e.g., one or more hardware processors) configured by machine-readable instructions including a module that is the same as or similar to the log player on/off module 838, in accordance with the example embodiments. The functions of block 951 can include one or more of the functions described with respect to the log player on/off module 838. As an example, the processor can log a player on or off with the log player on/off module 838 shown in FIG. 19.

Next, FIG. 26 shows a set 960 of functions. The set 960 includes functions shown in block 961. In accordance with the example embodiments, a method including one or more functions of the set 900, the set 910, the set 920, the set 930, the set 940, and/or the set 950 can include performing a function corresponding to block 961.

Block 961 includes executing an interrupt handler. The function(s) of block 961 can be performed by a processor (e.g., one or more hardware processors) configured by machine-readable instructions including a module that is the same as or similar to the execute interrupt module 840, in accordance with the example embodiments. The functions of block 961 can include one or more of the functions described with respect to the execute interrupt module 840. As an example, the processor can execute a software or hardware interrupt with the execute interrupt module 840 shown in FIG. 19.

Next, FIG. 27 shows a set 970 of functions. The set 970 includes functions shown in block 971. In accordance with the example embodiments, a method including one or more functions of the set 900, the set 910, the set 920, the set 930, the set 940, the set 950, and/or the set 960 can include performing a function corresponding to block 971.

Block 971 includes outputting a graphical user interface (GUI). The function(s) of block 971 can be performed by a processor (e.g., one or more hardware processors) configured by machine-readable instructions including a module that is the same as or similar to the output GUI module 842, in accordance with the example embodiments. The functions of block 971 can include one or more of the functions described with respect to the output GUI module 842. As an example, the processor can output a GUI with the output GUI module 842 shown in FIG. 19.

Next, FIG. 28 shows a set 980 of functions. The set 980 includes functions shown in block 981 to block 988. In accordance with the example embodiments, a method including one or more functions of the set 900, the set 910, the set 920, the set 930, the set 940, the set 950, the set 960, and/or the set 970 can include performing a function corresponding to one or more of block 981 to block 988.

Block 981 includes configuring a computing system to operate using a first jackpot state of a second set of jackpot states for a game with multiple jackpot states. The function(s) of block 981 can be performed by a processor (e.g., one or more hardware processors) configured by machine-readable instructions including a module that is the same as or similar to the configuration module 820, in accordance with the example embodiments. The functions of block 981 can include one or more of the functions described with respect to the configuration module 820. As an example, the processor can configure a computing system to operate using a first jackpot state of a second set of jackpot states for a game with multiple jackpot states with the configuration module 820 shown in FIG. 19.

Next, block 982 includes performing, in response to selection of the user-selectable control, a third instance of the game while the computing system operates using the first jackpot state of the second set of jackpot states. The function(s) of block 982 can be performed by a processor (e.g., one or more hardware processors) configured by machine-readable instructions including a module that is the same as or similar to the perform instance of game module 824, in accordance with the example embodiments. The functions of block 982 can include one or more of the functions described with respect to the perform instance of game module 824. As an example, the processor can perform, in response to selection of the user-selectable control, a third instance of the game while the computing system operates using the first jackpot state of the second set of jackpot states with the perform instance of game module 824 shown in FIG. 19.

Next, block 983 includes determining, an outcome of the third instance of the game, wherein the outcome of the third instance of the game includes an outcome to change from the first jackpot state of the second set of jackpot states to a second jackpot state of the second set of jackpot states. The function(s) of block 983 can be performed by a processor (e.g., one or more hardware processors) configured by machine-readable instructions including a module that is the same as or similar to the determine outcome of game module 826 in accordance with the example embodiments. The functions of block 983 can include one or more of the functions described with respect to the determine outcome of game module 826. As an example, the processor can determine, an outcome of the third instance of the game, wherein the outcome of the third instance of the game includes an outcome to change from the first jackpot state of the second set of jackpot states to a second jackpot state of the second set of jackpot states with the determine outcome of game module 826 shown in FIG. 19.

Next, block 984 includes outputting, on a display of the computing system, an outcome of the third instance of the game. The function(s) of block 984 can be performed by a processor (e.g., one or more hardware processors) configured by machine-readable instructions including a module that is the same as or similar to the output outcome of game module 828, in accordance with the example embodiments. The functions of block 984 can include one or more of the functions described with respect to the output outcome of game module 828. As an example, the processor can output, on a display of the computing system, an outcome of the third instance of the game with the output outcome of game module 828 shown in FIG. 19.

Next, block 985 includes configuring the computing system to operate using the second jackpot state of the second set of jackpot states for a fourth instance of the game. The function(s) of block 985 can be performed by a processor (e.g., one or more hardware processors) configured by machine-readable instructions including a module that is the same as or similar to the configuration module 820, in accordance with the example embodiments. The functions of block 985 can include one or more of the functions described with respect to the configuration module 820. As an example, the processor can configure the computing system to operate using the second jackpot state of the second set of jackpot states for a fourth instance of the game with the configuration module 820 shown in FIG. 19.

Next, block 986 includes performing, in response to selection of the user-selectable control, the fourth instance of the game while the computing system operates using the second jackpot state of the second set of jackpot states. The function(s) of block 986 can be performed by a processor (e.g., one or more hardware processors) configured by machine-readable instructions including a module that is the same as or similar to the perform instance of game module 824, in accordance with the example embodiments. The functions of block 986 can include one or more of the functions described with respect to the perform instance of game module 824. As an example, the processor can perform, in response to selection of the user-selectable control, the fourth instance of the game while the computing system operates using the second jackpot state of the second set of jackpot states with the perform instance of game module 824 shown in FIG. 19.

Next, block 987 includes determining an outcome of the fourth instance of the game. The function(s) of block 987 can be performed by a processor (e.g., one or more hardware processors) configured by machine-readable instructions including a module that is the same as or similar to the determine outcome of game module 826, in accordance with the example embodiments. The functions of block 987 can include one or more of the functions described with respect to the determine outcome of game module 826. As an example, the processor can determine an outcome of the fourth instance of the game with the determine outcome of game module 826 shown in FIG. 19.

Next, block 988 includes outputting, on the display of the computing system, the outcome of the fourth instance of the game. The function(s) of block 988 can be performed by a processor (e.g., one or more hardware processors) configured by machine-readable instructions including a module that is the same as or similar to the output outcome of game module 828, in accordance with the example embodiments. The functions of block 988 can include one or more of the functions described with respect to the output outcome of game module 828. As an example, the processor can output, on the display of the computing system, the outcome of the fourth instance of the game with the output outcome of game module 828 shown in FIG. 19.

### VI. Conclusions

While one or more disclosed functions have been described as being performed by a machine (e.g., the machine 50) or a computing system (e.g., the computing system 51, 100, 100A, 100B, 800), one or more of the functions can be performed by any entity, including but not limited to those described herein. As such, while this disclosure includes examples in which the computing system 100A performs select functions and sends data to the computing system 100B, such that the computing system 100B can perform complementing functions and receive the data, variations to those functions can be made while adhering to the general server-client dichotomy and the scope of the disclosed machines, computing systems, and methods.

For example, rather than the computing system 100A sending select data (e.g., a symbol set) to the computing system 100B, such that the computing system 100B can generate and display appropriate images, the computing system 100A can generate the images, animations, or GUIs and send them to the computing system 100B for display. Indeed, it will be appreciated by one of ordinary skill in the art that the “break point” between the server computing system's functions and the client computing system's functions can be varied.

Furthermore, the functions described throughout this can be performed in an order different than an order of functions (if any) described herein or shown in the drawings. Additionally, embodiments in the form of a method can include one or more of the functions described herein or shown in the drawings.

Furthermore still, while examples have been described in terms of select embodiments, alterations and permutations of these embodiments will be apparent to those of ordinary skill in the art. Other changes, substitutions, and alterations are also possible without departing from the disclosed machines, computing systems, and methods in their broader aspects as set forth in the claims below.

Finally, one or more embodiments described above may relate to one or more of the following enumerated example embodiments (EEE).

EEE 1 is a method comprising: configuring a computing system to operate using a first jackpot state for a game with multiple jackpot states; providing, at a user interface of the computing system, a user-selectable control to initiate each instance of the game; performing, in response to selection of the user-selectable control, a first instance of the game while the computing system operates using the first jackpot state; determining, an outcome of the first instance of the game, wherein the outcome of the first instance of the game includes an outcome to change from the first jackpot state to a second jackpot state; outputting, on a display of the computing system, an outcome of the first instance of the game; configuring the computing system to operate using the second jackpot state for a second instance of the game; performing, in response to selection of the user-selectable control, the second instance of the game while the computing system operates using the second jackpot state; determining an outcome of the second instance of the game; and outputting, on the display of the computing system, the outcome of the second instance of the game.

EEE 2 is the method of EEE 1, further comprising: providing the computing system with first control data, wherein the first control data includes the following for each jackpot state: a rate of incrementing a jackpot state of the game, a rate of incrementing the jackpot state and awarding a jackpot prize, and a jackpot value, wherein configuring the computing system to operate using the first jackpot state includes providing a random number generator with a request based on the first control data for the first jackpot state, and wherein configuring the computing system to operate using the second jackpot state includes providing the random number generator with a request based on the first control data for the second jackpot state.

EEE 3 is the method of EEE 2, wherein using the first jackpot state for the first instance of the game includes multiplying one or more jackpot values within the first control data based on an amount of a bet placed for the first instance of the game, and wherein using the second jackpot state for the second instance of the game includes multiplying one or more jackpot values within the first control data based on an amount of a bet placed for the second instance of the game.

EEE 4 is the method of any one of EEEs 2-3, wherein the multiple jackpot states are a first set of jackpot states, wherein a second set of jackpot states include multiple jackpot states, wherein the method further comprises providing the computing system with second control data, wherein the second control data includes the following for each jackpot state of the second set of jackpot states: a rate of incrementing a jackpot state of the game, a rate of incrementing the jackpot state and awarding a jackpot prize, and a jackpot value, and wherein the first control data is different than the second control data.

EEE 5 is the method of EEE 4, wherein the first control data is based on a first probability density function, wherein the second control data is based on a second probability density function, and wherein the first probability density function is different than the second probability density function.

EEE 6 is the method of EEE 5, wherein the first probability density function or the second probability density function defines a uniform win distribution, a normal win distribution, a log-normal win distribution, a linear win distribution, a polynomial win distribution, a sine win distribution, a sinc win distribution, or a custom win distribution.

EEE 7 is the method of any one of EEEs 4-6, wherein a quantity of jackpot states corresponding to the first control data is different than a quantity of jackpot states corresponding to the second control data.

EEE 8 is the method of any one of EEEs 4-7, further comprising: configuring the computing system to operate using a first jackpot state of the second set of jackpot states for the game with multiple jackpot states; performing, in response to selection of the user-selectable control, a third instance of the game while the computing system operates using the first jackpot state of the second set of jackpot states; determining, an outcome of the third instance of the game, wherein the outcome of the third instance of the game includes an outcome to change from the first jackpot state of the second set of jackpot states to a second jackpot state of the second set of jackpot states; outputting, on the display of the computing system, the outcome of the third instance of the game; configuring the computing system to operate using the second jackpot state of the second set of jackpot states for a fourth instance of the game; performing, in response to selection of the user-selectable control, the fourth instance of the game while the computing system operates using the second jackpot state of the second set of jackpot states; determining an outcome of the fourth instance of the game; and outputting, on the display of the computing system, the outcome of the fourth instance of the game.

EEE 9 is the method of any one of EEEs 1-8, wherein the multiple jackpot states include a sequence of jackpot states beginning at an initial jackpot state and ending at a final jackpot state, and wherein the sequence of jackpot states includes a penultimate jackpot state immediately before the final jackpot state.

EEE 10 is the method of EEE 9, wherein the first jackpot state is the initial jackpot state.

EEE 11 is the method of EEE 10, wherein the first jackpot state comprises an initial jackpot state of a sequence of jackpot states ending with a final jackpot state, and wherein configuring the computing system to operate using the first jackpot state occurs in response to one of the following: the computing system powering on from an off state, a processor of the computing system performing a software reset, a new player logging onto the computing system to play the game for an initial time, or completing a prior instance of the game during which a jackpot prize was awarded.

EEE 12 is the method of EEE 9, wherein the first jackpot state is an intermediate jackpot state between the initial jackpot state and the final jackpot state.

EEE 13 is the method of any one of EEEs 9-12, wherein determining the outcome of the second instance of the game includes determining the computing system is to increment to a third jackpot state for a next instance of the game, and wherein the third jackpot state includes an intermediate jackpot state between the second jackpot state and the final jackpot state.

EEE 14 is the method of any one of EEEs 9-13, wherein the second jackpot state is the penultimate jackpot state, wherein determining the outcome of the second instance of the game includes determining the computing system is to increment to the final jackpot state, and wherein outputting the outcome of the second instance of the game includes outputting an indication that a jackpot value corresponding to the final jackpot state has been awarded.

EEE 15 is the method of any one of EEEs 9-14, wherein the jackpot value corresponding to the final jackpot state is a maximum jackpot value defined for the multiple jackpot states.

EEE 16 is the method of any one of EEEs 9-15, wherein a distribution of wins over the multiple jackpot states is defined for the game.

EEE 17 is the method of EEE 9, wherein the multiple states includes between three and one thousand states.

EEE 18 is the method of EEE 9, wherein the multiples states include more than one thousand states.

EEE 19 is the method of any one of EEEs 9-18, wherein an outcome for each instance of the game includes one of the following outcomes: a no effect on jackpot outcome, an increment jackpot outcome, or an increment and award jackpot outcome.

EEE 20 is the method of EEE 19, wherein a probability corresponding to the no effect on jackpot outcome is

$${p}_{x}^{n} ,$$

wherein a probability corresponding to the increment jackpot outcome is

$${p}_{i}^{n} ,$$

wherein a probability corresponding to the increment and award jackpot outcome is

$${p}_{t}^{n} ,$$

wherein

$${p}_{x}^{n} + {p}_{i}^{n} + {p}_{t}^{n} = 1 ,$$

and wherein n corresponds to a current jackpot state the computing system is configured to use.

EEE 21 is the method of EEE 20, wherein the computing system is configured such that a maximum jackpot value is output in response to the increment and award jackpot outcome being achieved during an instance of the game while the computing system is configured to operate using the penultimate jackpot state.

EEE 22 is the method of any one of EEEs 20-21, wherein the computing system is configured such that the probability

$${p}_{i}^{n}$$

for each instance of the game while the computing system is configured to operate using the penultimate jackpot state is zero.

EEE 23 is the method of any one of EEEs 20-22, wherein the computing system is configured such that a jackpot value corresponding to the initial jackpot state is never awarded.

EEE 24 is the method of any one of EEEs 20-23, wherein the probability

$${p}_{t}^{n} = RTP / v ,$$

wherein v=a jackpot value corresponding to the current jackpot state the computing system is configured to use, and RTP=a return-to-player value selected for the game.

EEE 25 is the method of any one of EEEs 9-24, wherein a jackpot value corresponding to each jackpot state in the sequence of jackpot states increases from a minimum jackpot value corresponding to the initial jackpot state up to a maximum jackpot value corresponding to the final jackpot state.

EEE 26 is the method of EEE 25, wherein the jackpot values increase linearly as a jackpot state of the game increments from the initial jackpot state to the final jackpot state.

EEE 27 is the method of any one of EEEs 1-26, further comprising: selecting a first win distribution defined for the game, wherein the first win distribution prescribes the multiple jackpot states.

EEE 28 is the method of EEE 27, wherein the first win distribution comprises a uniform win distribution.

EEE 29 is the method of EEE 27, wherein the first win distribution comprises a normal win distribution.

EEE 30 is the method of EEE 27, wherein the first win distribution comprises a log-normal win distribution.

EEE 31 is the method of EEE 27, wherein the first win distribution comprises a linear win distribution.

EEE 32 is the method of EEE 27, wherein the first win distribution comprises a polynomial win distribution.

EEE 33 is the method of EEE 27, wherein the first win distribution comprises a sine win distribution.

EEE 34 is the method of EEE 27, wherein the first win distribution comprises a sinc win distribution.

EEE 35 is the method of EEE 27, wherein the first win distribution comprises a custom win distribution.

EEE 36 is the method of any one of EEEs 1-35, wherein providing the user-selectable control includes providing, at the computing system, a software interrupt and a graphical user interface including a virtual button, and wherein the method further comprises: executing, by a processor, the software interrupt in response to respective selections of the virtual button to initiate each instance of the game.

EEE 37 is the method of any one of EEEs 1-36, wherein providing the user-selectable control includes providing a hardware button, circuitry connecting the hardware button to a processor, and a software interrupt, the method further comprising: executing, by the processor, the software interrupt in response to respective selections of the hardware button to initiate each instance of the game.

EEE 38 is the method of any one of EEEs 1-37, further comprising: outputting, on the display, a graphical user interface (GUI), wherein providing the user-selectable control includes outputting a virtual button within the GUI, the virtual button corresponding to a particular area within the GUI; and executing, by a processor, a software interrupt in response to respective selections of the virtual button to initiate each instance of the game.

EEE 39 is the method of EEE 38, wherein the selection of the virtual button occurs via contact with the display at the particular area or via use of a pointing device while pointing to the particular area.

EEE 40 is the method of any one of EEEs 1-39, wherein outputting the outcome of the first instance of the game includes displaying, on the display, a first subset of symbols corresponding to a first virtual reel, wherein outputting the outcome of the second instance of the game includes displaying, on the display, a second subset of symbols corresponding to the first virtual reel, and wherein the first jackpot state and the second jackpot state correspond to outcomes of the game shown on the first virtual reel.

EEE 41 is the method of any one of EEEs 1-40, wherein outputting the outcome of the first instance of the game includes displaying, on the display, first subsets of symbols, each first subset of symbols corresponding to a respective one virtual reel of a set of virtual reels, wherein outputting the outcome of the second instance of the game includes displaying, on the display, second subsets of symbols, each second subset of symbols corresponding to the respective one virtual reel of the set of virtual reels, and wherein the first jackpot state and the second jackpot state correspond to outcomes of the game shown on the set of virtual reels.

EEE 42 is the method of any one of EEEs 1-41, wherein the game comprises a reel-based game including one or more virtual reels, wherein a first virtual reel of the one or more virtual reels corresponds to a first set of symbols, wherein a first subset of symbols from the first set of symbols is selected to represent the outcome of the first instance of the game, and wherein a second subset of symbols from the first set of symbols is selected to represent the outcome of the second instance of the game.

EEE 43 is the method of EEE 42, wherein the first subset of symbols matches the second subset of symbols, and wherein an order of all symbols within the first subset of symbols matches an order of all symbols within the second subset of symbols.

EEE 44 is the method of any one of EEEs 1-43, wherein determining the outcome of the second instance of the game includes determining the computing system is to continue operating using the second jackpot state for a next instance of the game.

EEE 45 is the method of any one of EEEs 1-44, further comprising: providing, at the computing system, a user-selectable control to alter a wager for the first instance of the game; and altering a jackpot value based on the wager for the first instance of the game.

EEE 46 is the method of any one of EEEs 1-45, wherein outputting the outcome of the first instance of the game includes outputting the outcome of the first instance of the game within a graphical user interface (GUI), wherein providing the user-selectable control to initiate the first instance of the game includes outputting, within the GUI, an icon corresponding to the user-selectable control to initiate each instance of the game, and wherein the icon is mapped to a particular location within the GUI.

EEE 47 is the method of any one of EEEs 1-46, wherein providing the user-selectable control to initiate each instance of the game includes a first user-selectable control and a second user-selectable control, wherein the first user-selectable control is configured to initiate one instance of the game for each use of the first user-selectable control, and wherein the second user-selectable control is configured to initiate auto-play of two or more instances of the game for each use of the second user-selectable control.

EEE 48 is the method of any one of EEEs 1-47, wherein the outcome of the first instance of the game further includes a monetary award less than a jackpot value defined for the multiple jackpot states and a wager placed on the first instance of the game.

EEE 49 is the method of any one of EEEs 1-48, wherein each instance of the game includes spinning and stopping multiple reels, and wherein a respective prize pot corresponds to each reel of the multiple reels.

EEE 50 is the method of EEE 49, wherein the respective prize pot corresponding to one or more of the multiple reels specifies an amount of prize money.

EEE 51 is the method of EEE 50, wherein the outcome to change from the first jackpot state to the second jackpot state corresponds to a particular reel of the multiple reels.

EEE 52 is the method of EEE 51, wherein the outcome of the first instance of the game includes no change to the respective prize pot corresponding to at least one reel of the multiple reels.

EEE 53 is the method of EEE 49, wherein the respective pot for corresponding to one or more of the multiple reels specifies a quantity of free spins of the game.

EEE 54 is the method of EEE 53, wherein the outcome to change from the first jackpot state to the second jackpot state corresponds to a particular reel of the multiple reels.

EEE 55 is the method of EEE 54, wherein the outcome of the first instance of the game includes no change to the respective prize pot corresponding to at least one reel of the multiple reels.

EEE 56 is the method of any one of EEEs 49-55, wherein the outcome of the first instance of the game include an amount of prize money won for a particular reel, a particular payway, or a particular payline without changing a jackpot state for the particular reel.

EEE 57 is the method of any one of EEEs 2-56, wherein providing the random number generator with the request based on the first control data includes providing the random number generator with a first non-negative integer equal to a sum of weights corresponding to output types available for the first instance of the game, and wherein providing the random number generator with the request based on the second control data includes providing the random number generator with a second non-negative integer equal to a sum of weights corresponding to output types available for the second instance of the game.

EEE 58 is the method of EEE 57, wherein the first non-negative integer equals the second non-negative integer.

EEE 59 is the method of any one of EEEs 57-58, further comprising: receiving from the random number generator one or more random numbers for the first instance of the game and one or more random numbers for the second instance of the game.

EEE 60 is the method of EEE 59, wherein the one or more random numbers for the first instance of the game includes a random number corresponding to an outcome type for the first instance of the game, and wherein the one or more random numbers for the second instance of the game includes a random number corresponding to an outcome type for the second instance of the game.

EEE 61 is the method of EEE 60, wherein the outcome type for the second instance of the game includes an output type with no effect on the second jackpot state, an output type to increment a jackpot state, or an output type to increment the jackpot state and output the jackpot prize.

EEE 62 is the method of any one of EEE 59-61, wherein the one or more random numbers for the first instance of the game include one or more random numbers to determine a set of symbols to output on each of one or more reels to represent a portion of the outcome of the first instance of the game.

EEE 63 is the method of EEE 62, wherein the one or more random numbers for the first instance of the game includes a quantity of N random numbers to determine a quantity of N sets of symbols for displaying within a quantity of N reels.

EEE 64 is the method of any one of EEE 59-63, wherein the one or more random numbers for the second instance of the game include one or more random numbers to determine a set of symbols to output on each of one or more reels to represent a portion of the outcome of the second instance of the game.

EEE 65 is the method of EEE 64, wherein the one or more random numbers for the second instance of the game includes a quantity of N random numbers to determine a quantity of N sets of symbols for displaying within a quantity of N reels.

EEE 66 is a computing system comprising a processor and a non-transitory computer-readable memory storing executable instructions, wherein execution of the instructions by the processor causes the computing system to perform the following functions: configuring the computing system to operate using a first jackpot state for a game with multiple jackpot states; providing, at a user interface of the computing system, a user-selectable control to initiate each instance of the game; performing, in response to selection of the user-selectable control, a first instance of the game while the computing system operates using the first jackpot state; determining, an outcome of the first instance of the game, wherein the outcome of the first instance of the game includes an outcome to change from the first jackpot state to a second jackpot state; outputting, on a display of the computing system, an outcome of the first instance of the game; configuring the computing system to operate using the second jackpot state for a second instance of the game; performing, in response to selection of the user-selectable control, the second instance of the game while the computing system operates using the second jackpot state; determining an outcome of the second instance of the game; and outputting, on the display of the computing system, the outcome of the second instance of the game.

EEE 67 is a computing system comprising: a processor, and a non-transitory computer-readable memory storing executable instructions, wherein execution of the executable instructions by the processor causes a computing system to perform the method of any one of EEE 1-65.

EEE 68 is a computer-readable memory having stored therein instructions executable by a processor to cause a computing system to perform functions comprising: configuring the computing system to operate using a first jackpot state for a game with multiple jackpot states; providing, at a user interface of the computing system, a user-selectable control to initiate each instance of the game; performing, in response to selection of the user-selectable control, a first instance of the game while the computing system operates using the first jackpot state; determining, an outcome of the first instance of the game, wherein the outcome of the first instance of the game includes an outcome to change from the first jackpot state to a second jackpot state; outputting, on a display of the computing system, an outcome of the first instance of the game; configuring the computing system to operate using the second jackpot state for a second instance of the game; performing, in response to selection of the user-selectable control, the second instance of the game while the computing system operates using the second jackpot state; determining an outcome of the second instance of the game; and outputting, on the display of the computing system, the outcome of the second instance of the game.

EEE 69 is a non-transitory computer-readable memory having stored therein instructions executable by a processor to cause a computing system to perform the method of any one of EEE 1-65.

1. A method comprising:
configuring a computing system to operate using a first jackpot state for a game with multiple jackpot states;
providing, at a user interface of the computing system, a user-selectable control to initiate each instance of the game;
performing, in response to selection of the user-selectable control, a first instance of the game while the computing system operates using the first jackpot state;
determining, an outcome of the first instance of the game, wherein the outcome of the first instance of the game includes an outcome to change from the first jackpot state to a second jackpot state;
outputting, on a display of the computing system, an outcome of the first instance of the game;
configuring the computing system to operate using the second jackpot state for a second instance of the game;
performing, in response to selection of the user-selectable control, the second instance of the game while the computing system operates using the second jackpot state;
determining an outcome of the second instance of the game; and
outputting, on the display of the computing system, the outcome of the second instance of the game.

2. The method of claim 1, further comprising:
providing the computing system with first control data,
wherein the first control data includes the following for each jackpot state:
a rate of incrementing a jackpot state of the game,
a rate of incrementing the jackpot state and awarding a jackpot prize, and
a jackpot value,
wherein configuring the computing system to operate using the first jackpot state includes providing a random number generator with a request based on the first control data for the first jackpot state, and
wherein configuring the computing system to operate using the second jackpot state includes providing the random number generator with a request based on the first control data for the second jackpot state.

3. The method of claim 2,
wherein the multiple jackpot states are a first set of jackpot states,
wherein a second set of jackpot states include multiple jackpot states,
wherein the method further comprises providing the computing system with second control data,
wherein the second control data includes the following for each jackpot state of the second set of jackpot states:
a rate of incrementing a jackpot state of the game,
a rate of incrementing the jackpot state and awarding a jackpot prize, and
a jackpot value, and
wherein the first control data is different than the second control data.

4. The method of claim 3, further comprising:
configuring the computing system to operate using a first jackpot state of the second set of jackpot states for the game with multiple jackpot states;
performing, in response to selection of the user-selectable control, a third instance of the game while the computing system operates using the first jackpot state of the second set of jackpot states;
determining, an outcome of the third instance of the game, wherein the outcome of the third instance of the game includes an outcome to change from the first jackpot state of the second set of jackpot states to a second jackpot state of the second set of jackpot states;
outputting, on the display of the computing system, the outcome of the third instance of the game;
configuring the computing system to operate using the second jackpot state of the second set of jackpot states for a fourth instance of the game;
performing, in response to selection of the user-selectable control, the fourth instance of the game while the computing system operates using the second jackpot state of the second set of jackpot states;
determining an outcome of the fourth instance of the game; and
outputting, on the display of the computing system, the outcome of the fourth instance of the game.

5. The method of claim 1,
wherein the multiple jackpot states include a sequence of jackpot states beginning at an initial jackpot state and ending at a final jackpot state, and
wherein the sequence of jackpot states includes a penultimate jackpot state immediately before the final jackpot state.

6. The method of claim 5,
wherein an outcome for each instance of the game includes one of the following outcomes:
a no effect on jackpot outcome,
an increment jackpot outcome, or
an increment and award jackpot outcome.

7. The method of claim 6,
wherein a probability corresponding to the no effect on jackpot outcome is
$${p}_{x}^{n} ,$$
wherein a probability corresponding to the increment jackpot outcome is
$${p}_{i}^{n} ,$$
wherein a probability corresponding to the increment and award jackpot outcome is
$${p}_{t}^{n} ,$$
wherein
$${p}_{x}^{n} + {p}_{i}^{n} + {p}_{t}^{n} = 1 ,$$
wherein n corresponds to a current jackpot state the computing system is configured to use.

8. The method of claim 7, wherein the computing system is configured such that a maximum jackpot value is output in response to the increment and award jackpot outcome being achieved during an instance of the game while the computing system is configured to operate using the penultimate jackpot state.

9. The method of claim 7, wherein the computing system is configured such that the probability
$${p}_{i}^{n}$$
for each instance of the game while the computing system is configured to operate using the penultimate jackpot state is zero.

10. The method of claim 7, wherein the computing system is configured such that a jackpot value corresponding to the initial jackpot state is never awarded.

11. The method of claim 7,
wherein the probability
$${p}_{t}^{n} = RTP / v ,$$
wherein v=a jackpot value corresponding to the current jackpot state the computing system is configured to use, and
RTP=a return-to-player value selected for the game.

12. The method of claim 5, wherein a jackpot value corresponding to each jackpot state in the sequence of jackpot states increases from a minimum jackpot value corresponding to the initial jackpot state up to a maximum jackpot value corresponding to the final jackpot state.

13. The method of claim 1, further comprising:
selecting a first win distribution defined for the game,
wherein the first win distribution prescribes the multiple jackpot states.

14. The method of claim 1,
wherein providing the user-selectable control includes providing, at the computing system, a software interrupt and a graphical user interface including a virtual button,
wherein the method further comprises: executing, by a processor, the software interrupt in response to respective selections of the virtual button to initiate each instance of the game.

15. The method of claim 1,
wherein providing the user-selectable control includes providing a hardware button, circuitry connecting the hardware button to a processor, and a software interrupt,
the method further comprising:
executing, by the processor, the software interrupt in response to respective selections of the hardware button to initiate each instance of the game.

16. The method of claim 1, further comprising:
outputting, on the display, a graphical user interface (GUI), wherein providing the user-selectable control includes outputting a virtual button within the GUI, the virtual button corresponding to a particular area within the GUI; and
executing, by a processor, a software interrupt in response to respective selections of the virtual button to initiate each instance of the game.

17. The method of claim 1,
wherein outputting the outcome of the first instance of the game includes displaying, on the display, a first subset of symbols corresponding to a first virtual reel,
wherein outputting the outcome of the second instance of the game includes displaying, on the display, a second subset of symbols corresponding to the first virtual reel, and
wherein the first jackpot state and the second jackpot state correspond to outcomes of the game shown on the first virtual reel.

18. The method of claim 1,
wherein outputting the outcome of the first instance of the game includes displaying, on the display, first subsets of symbols, each first subset of symbols corresponding to a respective one virtual reel of a set of virtual reels,
wherein outputting the outcome of the second instance of the game includes displaying, on the display, second subsets of symbols, each second subset of symbols corresponding to the respective one virtual reel of the set of virtual reels, and
wherein the first jackpot state and the second jackpot state correspond to outcomes of the game shown on the set of virtual reels.

19. A computing system comprising:
a processor; and
a non-transitory computer-readable memory storing executable instructions, wherein execution of the instructions by the processor causes the computing system to perform the following functions:
configuring the computing system to operate using a first jackpot state for a game with multiple jackpot states;
providing, at a user interface of the computing system, a user-selectable control to initiate each instance of the game;
performing, in response to selection of the user-selectable control, a first instance of the game while the computing system operates using the first jackpot state;
determining, an outcome of the first instance of the game, wherein the outcome of the first instance of the game includes an outcome to change from the first jackpot state to a second jackpot state;
outputting, on a display of the computing system, an outcome of the first instance of the game;
configuring the computing system to operate using the second jackpot state for a second instance of the game;
performing, in response to selection of the user-selectable control, the second instance of the game while the computing system operates using the second jackpot state;
determining an outcome of the second instance of the game; and
outputting, on the display of the computing system, the outcome of the second instance of the game.

20. A non-transitory computer-readable memory having stored therein instructions executable by a processor to cause a computing system to perform functions comprising:
configuring the computing system to operate using a first jackpot state for a game with multiple jackpot states;
providing, at a user interface of the computing system, a user-selectable control to initiate each instance of the game;
performing, in response to selection of the user-selectable control, a first instance of the game while the computing system operates using the first jackpot state;
determining, an outcome of the first instance of the game, wherein the outcome of the first instance of the game includes an outcome to change from the first jackpot state to a second jackpot state;
outputting, on a display of the computing system, an outcome of the first instance of the game;
configuring the computing system to operate using the second jackpot state for a second instance of the game;
performing, in response to selection of the user-selectable control, the second instance of the game while the computing system operates using the second jackpot state;
determining an outcome of the second instance of the game; and
outputting, on the display of the computing system, the outcome of the second instance of the game.
